(19) United States
(12) Patent Application Publication
(10) Pub. No.: US 2018/0264801 A1
(43) Pub. Date: Sep. 20, 2018

(54) FORMATION OF SUBSTRATES HAVING INK INCLUDING MAGNETIC MATERIAL

(71) Applicants: Masaaki FUKUMOTO, Beijing (CN); Masayasu OGATA, Beijing (CN); MICROSOFT TECHNOLOGY LICENSING, LLC, Redmond, WA (US)

(72) Inventors: Masaaki FUKUMOTO, Beijing (CN); Masayasu OGATA, Beijing (CN)

(73) Assignee: MICROSOFT TECHNOLOGY LICENSING, LLC, Redmond, WA (US)

(21) Appl. No.: 15/543,895

(22) PCT Filed: Jan. 16, 2015
(86) PCT No.: PCT/CN2015/070852

§ 371 Date: Jul. 14, 2017

(51) Int. Cl. B41F 19/00; B41M 3/00; B41J 3/44; B41J 3/54; B42D 25/369; B42F 11/04; C09D 11/328

(52) U.S. Cl. CPC B41F 19/005; B41M 3/00; B41F 19/007; C09D 11/328; B41J 3/543; B42D 25/369; B42F 11/04; B41J 3/44

(57) ABSTRACT

Implementations described herein are directed to depositing a magnetic ink onto a substrate. The magnetic ink is deposited on a portion of a substrate such that the amount of magnetic ink is divided into a plurality of sections where individual sections of the plurality of sections can be spaced at substantially regular intervals. Additionally, individual sections of the plurality of sections can have a common shape. A plurality of substrates having magnetic ink deposited on surfaces of the plurality of substrates as described according to implementations herein can be used to form objects having a number of shapes and structures.

### BACKGROUND

Many printing devices operate to place ink onto a substrate. Some printing devices may include one or more nozzles that dispose droplets of ink onto a substrate according to data provided to the printing device. Printing devices may also include one or more motors that move the nozzles across portions of the substrate in order to dispense the ink onto the substrate and one or more motors that may feed the substrate through the printing device. Ink may be arranged on a substrate in a manner that is recognizable by a human, such as in the form of characters (e.g., letters, numbers, symbols) or pictures. Ink may also be arranged on a substrate to be recognized by a machine, such as a bar code.

In some instances, ink including a magnetic material may be printed onto a substrate in order to encode data on the substrate. The magnetic ink may be printed on the substrate in addition to ink that does not include a magnetic material. The magnetic ink may be disposed on a substrate to convey information that is human readable (e.g., magnetic ink character recognition code), information that is machine readable (e.g. magnetic stripe), or both.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

This application is directed to disposing ink including magnetic material onto a substrate. In some instances, ink including magnetic material can be referred to herein as “magnetic ink.” The magnetic ink can be disposed on at least a portion of a surface of the substrate such that the amount of magnetic ink is divided into a plurality of sections. Individual sections of the plurality of sections can be spaced at substantially regular intervals. Additionally, individual sections of the plurality of sections can have a common shape.

A substrate having an ink including a magnetic material can be produced by an apparatus that includes a container that stores the ink including the magnetic material. The apparatus can dispose the magnetic ink onto the substrate according to data received by the apparatus. The data and instructions for processing the data can be stored by one or more computer-readable storage media of the apparatus. The apparatus can also include a magnetizing device that magnetizes the magnetic material disposed on the substrate. In some cases, the magnetizing device can apply a magnetic field that produces a particular alignment of the magnetic material.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an example framework to dispose ink including magnetic material onto a substrate.

FIG. 2 illustrates an example apparatus to dispose an ink including magnetic material onto a substrate, to dispose an ink that does not include magnetic material onto the substrate, and to magnetize the magnetic material.

FIG. 3 illustrates an example device to magnetize magnetic material disposed on a surface of a substrate in a direction perpendicular to the surface of the substrate.

FIG. 4 illustrates an example device to magnetize material disposed on a surface of a substrate in a direction parallel to the surface of the substrate.

FIG. 5 illustrates a substrate including a first region having a layer of magnetic ink that is disposed substantially continuously in the first region and a second region having magnetic ink that is disposed in a plurality of sections arranged at regular intervals and having a common shape.

FIG. 6 illustrates a number of substrates that include portions of magnetic ink disposed on surfaces of the substrates and that have a magnetic force.

FIG. 7 illustrates a number of substrates that include portions of magnetic ink disposed on surfaces of the substrates and that have a magnetic force.

FIG. 8 illustrates a number of substrates that include portions of magnetic ink disposed on surfaces of the substrate and that have magnetic fields disposed on the substrates to cause the number of substrates to align to form an object.

FIG. 9 illustrates an apparatus having a surface and including a magnetic device to move substrates coupled to the surface of the apparatus from a first location on the surface to a second location on the surface.

FIG. 10 illustrates an apparatus where magnetic forces can be applied to different portions of a substrate to move the substrate from a first location on a surface of the apparatus to a second location on the surface of the apparatus.

FIG. 11 illustrates an arrangement of a magnetic ink on a first substrate, an arrangement of magnetic ink on a second substrate, and magnetic devices including a number of magnetic components.

FIG. 12 illustrates a pattern of activating magnetic components of the first magnetic device and magnetic components of the second magnetic device of the apparatus of FIG. 11.

FIG. 13 illustrates selection of the first substrate according to attractive and repelling forces of magnetic components of the first magnetic device and the second magnetic device of the apparatus of FIG. 11.

FIG. 14 illustrates the use of a magnetic device to form objects from a substrate having magnetic material disposed on surfaces of the substrate.

FIG. 15 illustrates a flow diagram of an example process to form a substrate having a magnetic material disposed on at least one surface of the substrate.

FIG. 16 illustrates magnetic ink disposed on a surface of a substrate in a substantially continuous manner and magnetic ink disposed on the surface of the substrate in a plurality of sections and the simulated result of corresponding magnetic fields produced by the different arrangements of magnetic ink on the surface of the substrate.

FIG. 17 illustrates results of simulations used to identify optimal magnetic ink printing patterns.

### DETAILED DESCRIPTION

The technologies described herein are generally directed to disposing a magnetic ink onto a substrate. In particular, magnetic ink is disposed on a portion of a substrate such that the amount of magnetic ink is divided into a plurality of sections where individual sections of the plurality of sections can be spaced at substantially regular intervals. In some cases, the substrate can be a paper substrate that is fed into an apparatus that includes components to eject the magnetic ink onto a surface of the substrate. In an implementation, the individual sections of the plurality of sections can have a common shape. By arranging the magnetic ink onto a substrate in this manner the magnetic field produced by the magnetic ink can be strong enough to attract other portions of magnetic ink disposed on additional substrates. In this way, a plurality of substrates having magnetic ink disposed described according to implementations herein can form objects having a number of shapes and structures when placed in proximity with each other. Furthermore, in some scenarios, a non-magnetic ink can be dispensed onto a surface of the substrate. The non-magnetic ink can be dispensed onto the surface of the substrate to form characters and/or pictures on the surface of the substrate.

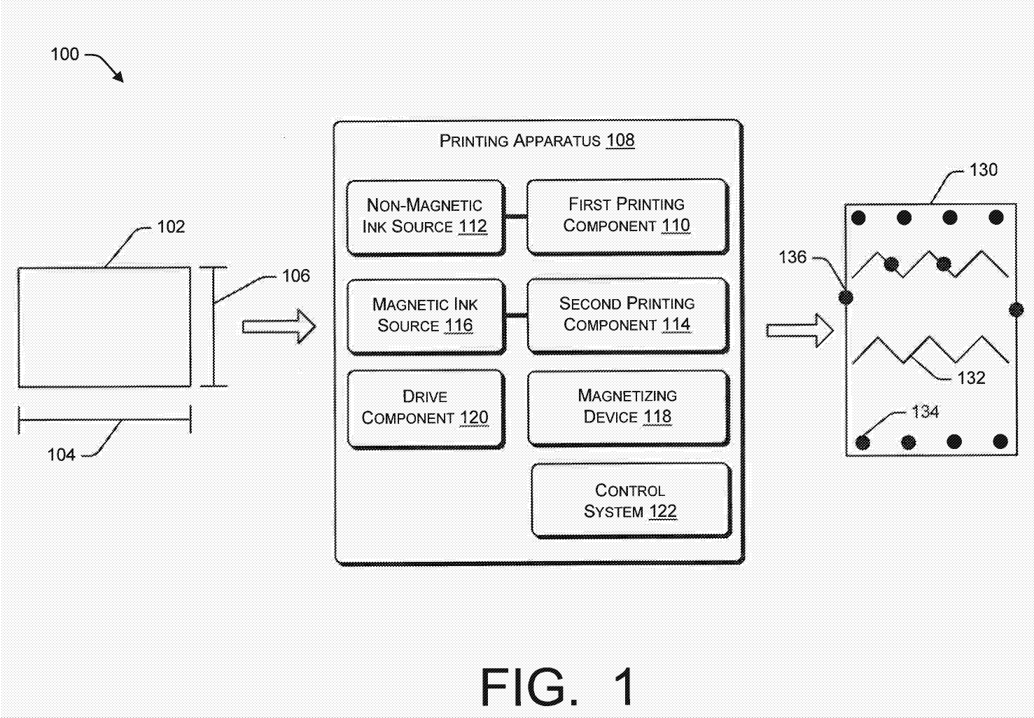

FIG. 1 illustrates an example framework 100 to dispose ink including magnetic material onto a substrate 102. The substrate 102 can include cellulose, in some scenarios. To illustrate, the substrate 102 can be a paper substrate. In some cases, the substrate 102 can be a single sheet of material. In these situations, the substrate 102 can have various dimensions, such as a first dimension 104 and a second dimension 106. For example, the first dimension 104 of the substrate 102 can be included in a range of about 100 mm to about 300 mm. In another example, the second dimension 106 of the substrate 102 can be included in a range of about 125 mm to about 450 mm. Additionally, when the substrate 102 is a single sheet of material, the substrate 102 can have the first dimension 104 with a value included in a range of about 205 mm to about 230 mm and the second dimension 106 with a value included in a range of about 265 mm to about 290 mm. In another illustration, the substrate 102 can have the first dimension 104 with a value included in a range of about 205 mm to about 230 mm and the second dimension 106 with a value included in range of about 280 mm to about 310 mm. In an additional illustration, the substrate 102 can have the first dimension 104 with a value included in a range of about 265 mm to about 295 mm and the second dimension 106 with a value included in a range of about 410 mm to about 445 mm. The substrate 102 can also be a roll of material. In situations where the substrate 102 is a roll of material, the substrate 102 can have the first dimension 104 with a value of several meters, such as a value included in a range of about 1 m to about 30 m, and a second dimension 106 with a value included in a range of about 80 mm to about 500 mm. The substrate 102 can also a thickness included in a range of about 0.05 mm to about 0.5 mm. In another example, the substrate 102 can have a thickness included in a range of about 0.07 mm to about 0.25 mm. In an additional example, the substrate 102 can have a thickness included in a range of about 0.08 mm to about 0.15 mm.

The framework 100 can also include a printing apparatus 108 that operates to dispose ink onto the substrate 102. The printing apparatus 108 can include one or more components for dispensing ink onto the substrate 102. For example, the printing apparatus 108 can include a first printing component 110 for dispensing non-magnetic ink onto the substrate 102. The first printing component 110 can be coupled to at least one non-magnetic ink source 112 that stores non-magnetic ink. As used herein, the term “non-magnetic ink” refers to ink that is free of magnetic material or contains trace amounts of magnetic material. The non-magnetic ink can include one or more components. To illustrate, the non-magnetic ink can be an aqueous ink that includes water and at least one color-containing element. In some cases, the at least one color-containing element can include one or more dyes. In other cases, the at least one color-containing element can include one or more pigments. The non-magnetic ink can also include a water soluble solvent. Additionally, the non-magnetic ink can include a surfactant. Further, the non-magnetic ink can include one or more additional components, such as a buffer, a chelating agent, a solubilizer, other components, or combinations thereof.

In an illustrative implementation, non-magnetic ink can be fed into the first printing component 110 from the at least one non-magnetic ink source 112. To illustrate, the non-magnetic ink can be fed into the first printing component 110 by a pump. The first printing component 110 can include one or more nozzles that dispense non-magnetic ink onto the substrate 102. In some cases, the first printing component 110 can dispense droplets of the non-magnetic ink onto the substrate 102. In a particular example, pressure, heat, or both can be applied to non-magnetic ink obtained from the at least one non-magnetic ink source 112 to eject the non-magnetic ink through one or more nozzles of the first printing component 110 onto the substrate 102.

The printing apparatus 108 can also include a second printing component 114 to dispense magnetic ink onto the substrate 102. The second printing component 114 can be coupled to at least one magnetic ink source 116 that stores magnetic ink. As used herein, the term “magnetic ink” refers to ink that includes more than trace amounts of a magnetic material. The magnetic material included in the magnetic ink can include Neodymium (Nd), in some cases. In addition, the magnetic material included in the magnetic ink can include Niobium (Nb), in some scenarios. Further, the magnetic material included in the magnetic ink can include Boron (B). In still other instances, the magnetic material included in the magnetic ink can include Iron (Fe). In an illustrative implementation, the magnetic material can include a combination of Nd, Fe, and B. For example, the magnetic material included in the magnetic ink can include Nd₂Fe₁₄B. In another illustrative implementation, the magnetic material can include a combination of Nd, Fe, Nb, and B.

In an implementation, the magnetic ink can include at least about 40% magnetic material by volume of a total volume of the magnetic ink, at least about 50% magnetic material by volume of a total volume of the magnetic ink, or at least about 60% magnetic material by volume of a total volume of the magnetic ink. Additionally, the magnetic ink can include no greater than about 90% magnetic material by volume of a total volume of the magnetic ink, no greater than about 80% magnetic material by volume of a total volume of the magnetic ink, or no greater than about 70% magnetic material by volume of a total volume of the magnetic ink. In an illustrative implementation, the magnetic ink can include an amount of magnetic material included in a range of about 45% by volume to about 85% by volume of a total volume of the magnetic ink. In another illustrative implementation, the magnetic ink can include an amount of magnetic material included in a range of about 65% by volume to about 85% by volume of a total volume of the magnetic ink. In an additional illustrative implementation, the magnetic ink can include an amount of magnetic material included in a range of about 72% by volume to about 82% by volume of a total volume of the magnetic ink.

Further, the magnetic ink can include particles of magnetic material having a d50 of no greater than about 150 micrometers, no greater than about 125 micrometers, no greater than about 110 micrometers, no greater than about 90 micrometers, no greater than about 75 micrometers, or no greater than about 50 micrometers. The magnetic ink can also include particles of magnetic material having a d50 of at least about 2 micrometers, at least about 5 micrometers, at least about 10 micrometers, at least about 20 micrometers, at least about 25 micrometers, or at least about 30 micrometers. In an illustrative example, the magnetic ink can include particles having a d50 included in a range of about 2 micrometers to about 25 micrometers. In another illustrative example, the magnetic ink can include particles having a d50 included in a range of about 3 micrometers to about 10 micrometers.

In some cases, the magnetic ink can be an aqueous magnetic ink. In other situations, the magnetic ink can be a non-aqueous magnetic ink. Additionally, the magnetic ink can include an epoxy resin. In an illustrative example, a ratio of a volume of magnetic material to a volume of epoxy resin in the magnetic ink can be included in a range of about 2.5:1 to about 4:1. In another illustrative example, a ratio of volume of magnetic material to a volume or epoxy resin in a magnetic ink can be included in a range of about 3.2:1 to about 3.6:1. The magnetic ink can include additional components, such as one or more solvents, one or more surfactants, other components, or combinations thereof.

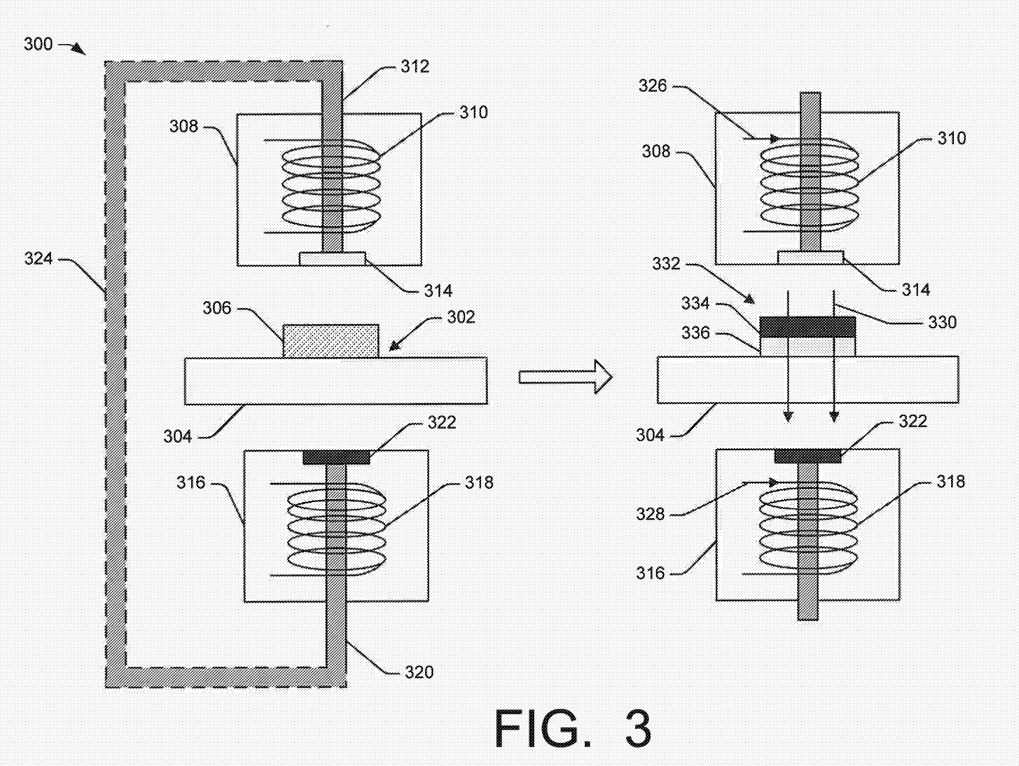

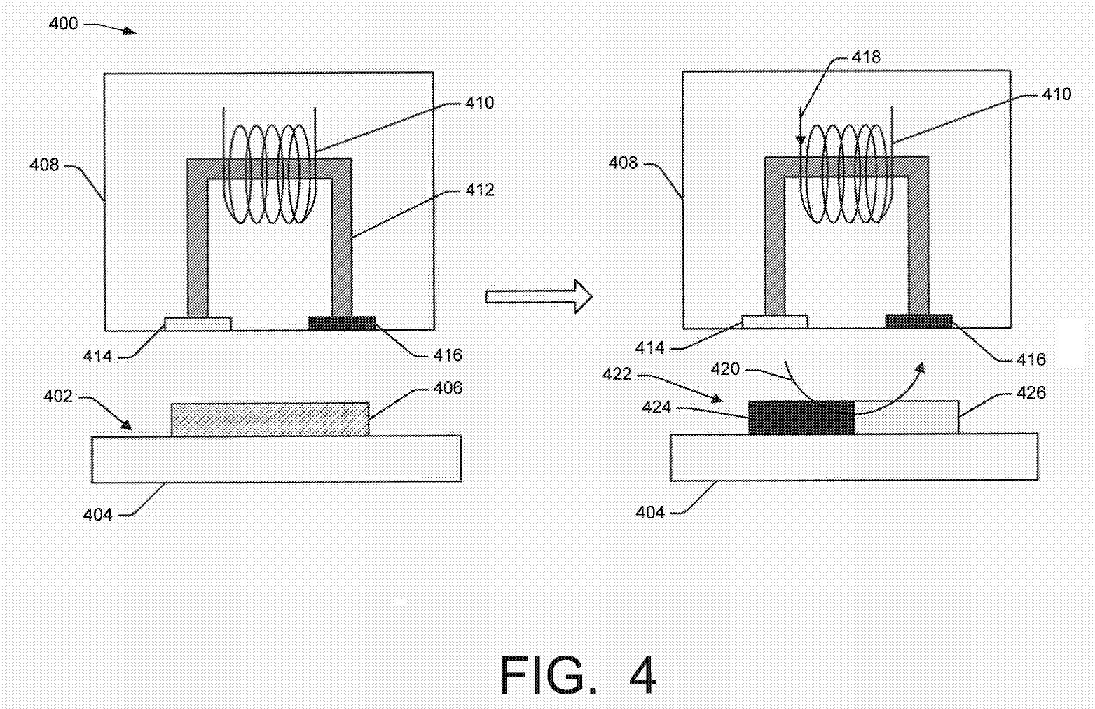

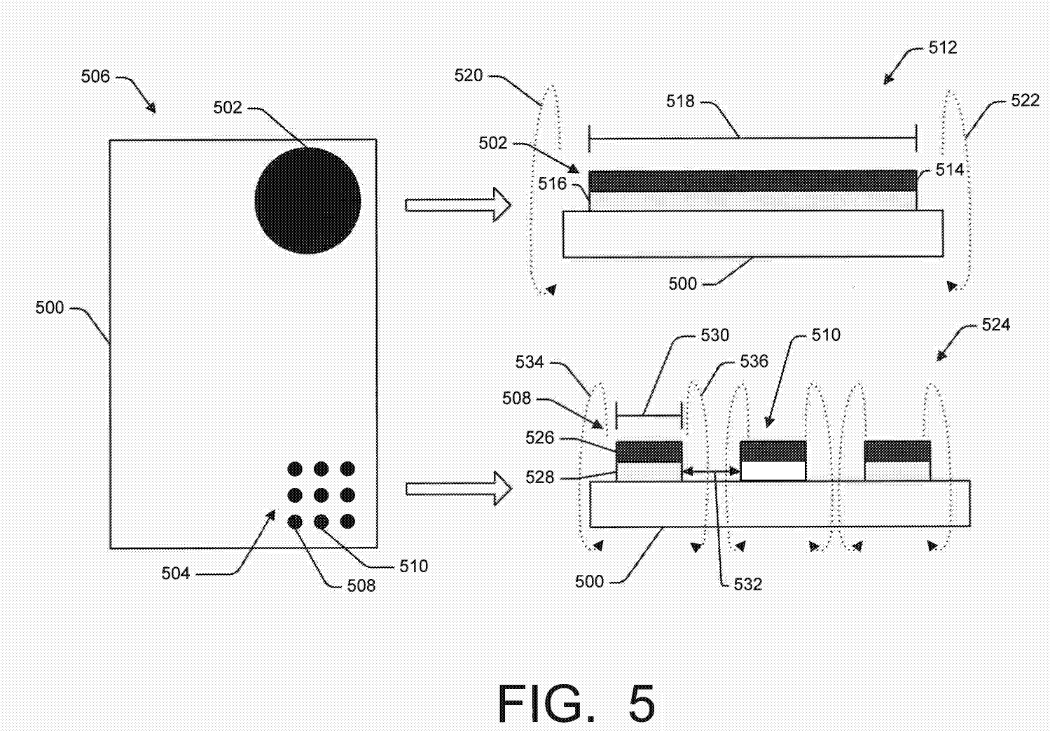

The printing apparatus 108 can also include one or more magnetizing devices represented by magnetizing device 118. The magnetizing device 118 can include a magnet that produces a magnetic field. In an implementation, the magnetizing device 118 can be positioned proximate to portions of magnetic ink that have been printed on the substrate 102. In these cases, the magnetizing device 118 can apply a magnetic field to the magnetic ink and align magnetic particles of the magnetic ink along a direction of the magnetic field. In one example, the magnetizing device 118 can cause magnetic particles of the magnetic ink to be aligned according to a first polarity. In another example, the magnetizing device 118 can cause magnetic particles of the magnetic ink to be aligned according to a second polarity that is opposite the first polarity. In a particular implementation, the printing apparatus 108 can include a first magnetizing device that aligns magnetic particles of the magnetic ink according to the first polarity and a second magnetizing device that aligns magnetic particles of the magnetic ink according to the second polarity. For example, the printing apparatus 108 can include a first magnet and a north pole of the first magnet can be applied to a first portion of the magnetic particles of the magnetic ink disposed on the substrate 102 giving the first portion of the magnetic particles a first polarity. Continuing with this example, the printing apparatus 108 can include a second magnet and a south pole of the second magnet can be applied to a second portion of the magnetic particles of the magnetic ink disposed on the substrate 102 giving the second portion of the magnetic particles a second polarity. The alignment of particles of the magnetic material of the magnetic ink disposed on the substrate 102 will be described in more detail with respect to FIG. 3, FIG. 4, and FIG. 5.

The printing apparatus 108 can also include a drive component 120 that can move the first printing component 110 in order to dispense the non-magnetic material onto the substrate 102. Additionally, drive component 120 can move the second printing component 114 in order to dispense magnetic ink onto the substrate 102. Further, the drive component 120 can move the magnetizing device 118 to apply a magnetic field to portions of the substrate 102 that include magnetic ink in order to magnetize the magnetic ink disposed on the substrate 102. The drive component 120 can include one or more motors, one or more belts, one or more microcontrollers, or combinations thereof, that operate to move the first printing component 120, the second printing component 114, the magnetizing device 118, or a combination thereof. In a particular implementation, the drive component 120 can include one or more stepper motors.

In an implementation, the printing apparatus 108 can include a control system 122 that controls the first printing component 110, the second printing component 114, the magnetizing device 118, the drive component 120, or a combination thereof For example, the control system 122 can send signals to the first printing component 110 to control the movement of the first printing component 110 across the substrate 102 and to control dispensing non-magnetic ink onto the substrate 102. In other cases, the control system 122 can send signals to the second printing component 114 to control the movement of the second printing component 114 across the substrate 102 and to control dispensing magnetic ink onto the substrate 102.

The control system 122 can also send signals to the magnetizing device 118 to cause the magnetizing device 118 to generate a magnetic field and move the magnetizing device 118 such that the magnetic field is applied to portions of the substrate 102 that include magnetic material. In some cases, the control system 122 can send signals to the magnetizing device 118 to apply a magnetic field to portions of the substrate including magnetic material in order to produce portions of the substrate having a first polarity and/or to produce portions of the substrate 102 having a second polarity that is opposite the first polarity. For example the control system 122 can send signals to the magnetizing device 118 to produce one or more portions of the substrate 102 having a north polarity, to produce one or more portions of the substrate having a south polarity, or to send signals to the magnetizing device 118 to produce one or more portions of the substrate 102 that have a north polarity and to produce one or more portions of the substrate 102 that have a south polarity.

In some cases, the substrate 102 can be one of a plurality of individual substrates that are individually fed through the apparatus 104. In other cases, the substrate 102 can be part of a roll of material that is fed through the apparatus 104. In these situations, the printing apparatus 108 can include a cutting device to cut the roll of material and produce a number of substrates from the roll of material. In an illustrative example, the substrate 102 can be fed through the printing apparatus 108 using one or more motors.

The printing apparatus 108 can perform a number of functions to transform the substrate 102 into a printed substrate 130. The printed substrate 130 can include one or more portions of non-magnetic ink represented by first portion 132. The first portion 132 can include characters, symbols, pictures, or a combination thereof. The printed substrate 130 can also include one or more portions of magnetic ink represented by the second portion 134. In some cases, the second portion 134 can include one or more individuals sections of magnetic ink that are spaced at regular intervals. The second portion 134 can also include individual sections of magnetic ink that have a common shape. The second portion 134 can also produce a magnetic field that can attract or repel portions of magnetic ink disposed on an additional substrate. In addition to having portions of magnetic ink disposed within boundaries of the printed substrate 130, the printed substrate 130 can also include portions of magnetic ink disposed along the boundaries of the printed substrate, such as a third portion 136. Furthermore, some portions of non-magnetic ink on the printed substrate 130 can overlay portions of magnetic ink on the printed substrate 130.

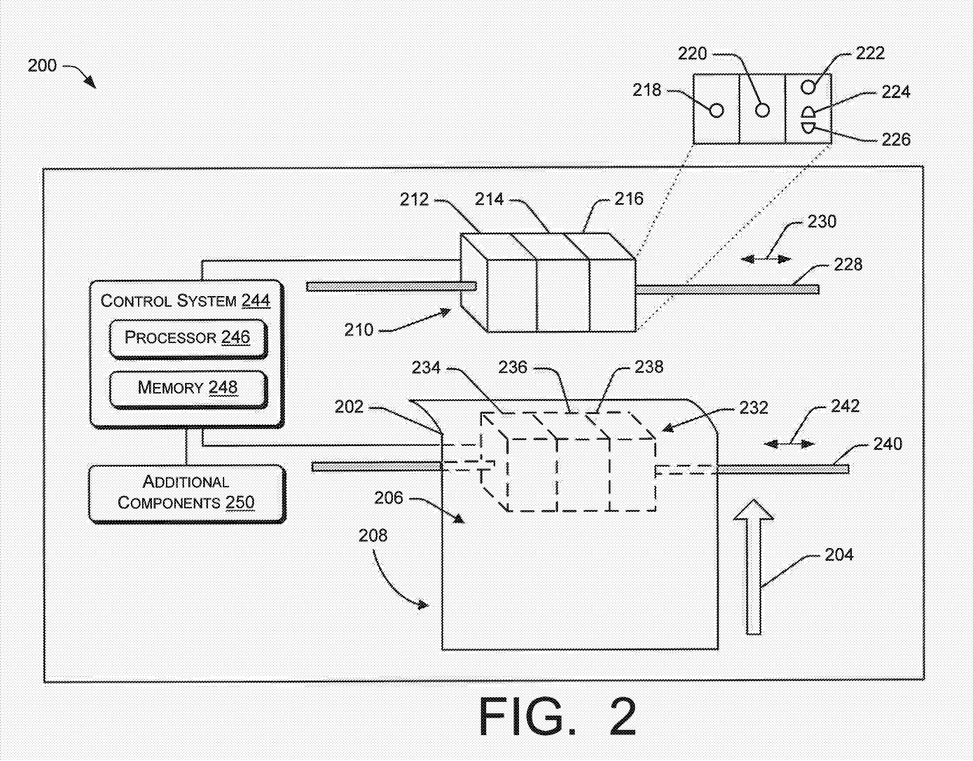

FIG. 2 illustrates an example apparatus 200 to dispose an ink including magnetic material onto a substrate 202, to dispose an ink that does not include magnetic material onto the substrate 202, and to magnetize the magnetic material. The substrate 202 can be fed through the apparatus 200 in a direction 204. The substrate 202 can have a first surface 206 and a second surface 208 that is opposite the first surface 206 and parallel to the first surface 206. In an implementation, the apparatus 200 can correspond to the printing apparatus 108 of FIG. 1 and the substrate 202 can correspond to the substrate 102 of FIG. 1.

The apparatus 200 can also include a first housing 210 that includes a first non-magnetic ink printing component 212 and a first magnetic ink printing component 214. In an implementation, the first non-magnetic ink printing component 212 can dispense a non-magnetic ink onto the first side 206 of the substrate 202 and the first magnetic ink printing component 214 can dispense a magnetic ink onto the first side 206 of the substrate 202. In some cases, the first non-magnetic ink printing component 212 can include a first container that stores the non-magnetic ink and the first magnetic ink printing component 214 can include a second container that stores the magnetic ink. In other cases, the first non-magnetic ink printing component 212 can be coupled to one or more first non-magnetic ink containers that include non-magnetic ink via one or more first non-magnetic ink transport components. In a particular implementation, the one or more first non-magnetic ink containers can store different non-magnetic inks. To illustrate, a black ink can be stored in one first magnetic ink container and one or more colored inks can be stored in respective additional first non-magnetic ink containers. In situations where the first non-magnetic ink containers include multiple first non-magnetic ink containers, additional volumes of the same non-magnetic ink can be stored in at least a portion of the first non-magnetic ink containers.

Additionally, the first magnetic ink printing component 214 can be coupled to one or more first magnetic ink containers that include the magnetic ink via first magnetic ink transport components. The one or more first magnetic ink containers can also include multiple first magnetic ink containers that store different magnetic inks and/or additional volumes of the same magnetic ink. The first non-magnetic ink transport components and the first magnetic ink transport components can individually include tubing, a pump, or both. The first housing 210 can also include a magnetizing device 216 that applies a magnetic field to at least some of the portions of the first side 206 of the substrate 202 that include magnetic ink.

FIG. 2 shows an expanded view of the housing 210 illustrating that the first non-magnetic ink printing component 212 can include one or more first orifices represented by first orifice 218 and that the first magnetic ink printing component 214 can include one or more second orifices represented by second orifice 220. In an implementation, the first non-magnetic ink printing component 212 can dispense non-magnetic ink onto the first side 206 of the substrate 202 via the first orifice 218 and the first magnetic ink printing component 214 can dispense magnetic ink onto the first side 206 of the substrate 202 via the second orifice 220. In some cases, the first orifice 218 can be part of a nozzle included as part of the first non-magnetic ink printing component 212 and the second orifice 220 can be part of a nozzle included as part of the first magnetic ink printing component 214.

The expanded view of the housing 210 also shows that the magnetizing device 216 can include a first magnetic component 222, a second magnetic component 224, and a third magnetic component 226. In an implementation, the first magnetic component 222, the second magnetic component 224, and the third magnetic component 224 can each include a plate comprised of a magnetic metal. The respective plates of the first magnetic component 222, the second magnetic component 224, and the third magnetic component 226 can be coupled to a respective coil and a magnetic field can be generated when current is propagated through the coil. In some cases, the first magnetic component 222 can be used to produce an alignment of magnetic material disposed on the first surface 206 of the substrate 202 in a direction that is perpendicular to the first surface 206 of the substrate 202. Additionally, the second magnetic component 224 and the third magnetic component 226 can be used to produce an alignment of magnetic material disposed on the first surface 206 of the substrate 202 in a direction that is parallel to the first surface 206 of the substrate 202. The alignment of magnetic material disposed on substrates will be discussed in more detail with respect to FIG. 3 and FIG. 4.

Furthermore, although the illustrative example of FIG. 1 shows that the first magnetizing device 216 includes the first magnetic component 222, the second magnetic component 224, and the third magnetic component 226, in some scenarios, the first magnetizing device 216 can include the first magnetic component 222 and exclude the second magnetic component 224 and the third magnetic component 226. In other implementations, the first magnetizing device 216 can include the second magnetic component 224 and the third magnetic component 226 and exclude the first magnetic component 222.

The apparatus 200 can also include a first rail 228. The first housing 210 can be disposed on the first rail 228 such that the first housing 210 can move in directions indicated by the arrow 230. The movement of the first housing 210 along the first rail 228 can be controlled to locate the first non-magnetic ink printing component 212 to dispense non-magnetic ink onto particular portions of the first side 206 of the substrate 202. Additionally, the movement of the first housing 210 along the first rail 228 can be controlled to locate the first magnetic ink printing component 214 to dispense magnetic ink onto particular portions of the first side 206 of the substrate 202. Further, the movement of the first housing 210 along the first rail 228 can be controlled to locate the first magnetizing device 216 to apply a magnetic field to magnetic material disposed on particular portions of the first side 206 of the substrate 202 to magnetize the magnetic material.

The apparatus 200 can also include a second housing 232 that includes a second non-magnetic ink printing component 234 and a second magnetic ink printing component 236. The second housing 232 can be located under the substrate 202 as the substrate 202 is fed through the apparatus 200. In an implementation, the second non-magnetic ink printing component 234 can dispense a non-magnetic ink onto the second side 208 of the substrate 202 and the second magnetic ink printing component 236 can dispense a magnetic ink onto the second side 208 of the substrate 202. In some cases, the second non-magnetic ink printing component 234 can include a second non-magnetic ink container that stores the non-magnetic ink and the second magnetic ink printing component 236 can include a second magnetic ink container that stores the magnetic ink. In other cases, the second non-magnetic ink printing component 234 can be coupled to the second non-magnetic ink container that includes the non-magnetic ink via a second non-magnetic ink transport component and the second magnetic ink printing component 236 can be coupled to a second magnetic ink container that includes the magnetic ink via a second magnetic ink transport component. The second non-magnetic ink transport component and the second magnetic ink transport component can individually include tubing, a pump, or both. The second housing 232 can also include a second magnetizing device 238 that applies a magnetic field to at least some of the portions of the second side 208 of the substrate 202 that include magnetic material.

The apparatus 200 can also include a second rail 240. The second housing 232 can be disposed on the second rail 240 such that the second housing 232 can move in directions indicated by the arrow 242. The movement of the second housing 232 along the second rail 240 can be controlled to locate the second non-magnetic ink printing component 234 to dispense non-magnetic ink onto particular portions of the second side 208 of the substrate 202. Additionally, the movement of the second housing 232 along the second rail 240 can be controlled to locate the second magnetic ink printing component 236 to dispense magnetic ink onto particular portions of the second side 208 of the substrate 202. Further, the movement of the second housing 232 along the second rail 240 can be controlled to locate the second magnetizing device 238 to apply a magnetic field to magnetic material disposed on particular portions of the second side 208 of the substrate 202 to magnetize the magnetic material.

Although not shown in FIG. 2, the second non-magnetic ink printing component 234 can include an arrangement of orifices similar to that described with respect to the first non-magnetic ink printing component 212. Also, the second magnetic ink printing component 236 can include an arrangement of orifices similar to that described with respect to the first magnetic ink printing component 214. In addition, the second magnetizing device 238 can include an arrangement of magnetic components similar to that described with respect to the first magnetizing device 216. Further, in some implementations, the second housing 232, the second non-magnetic ink printing component 234, the second magnetic ink printing component 236, the second magnetizing device 238, or a combination thereof, can be optionally included in the apparatus 200.

The apparatus 200 can also include a control system 244. The control system 244 can include one or more hardware processor devices represented by processor 246 and one or more physical memory devices represented by memory 248. In some cases, the processor 246 can be a single processing unit or a number of processing units, any of which may include single or multiple computing units or multiple cores. Additionally, the processor 246 can be implemented as one or more microprocessors, microcomputers, microcontrollers, digital signal processors, central processing units, state machines, logic circuitries, and/or any devices that manipulate signals based on operational instructions. Among other capabilities, the processor 246 can be configured to fetch and execute computer-readable instructions, such as computer readable instructions stored in the memory 248.

The memory 248 can be examples of computer storage media for storing instructions which are executed by the processor 246 to perform various functions. In an example, the memory 248 can generally include both volatile memory and non-volatile memory (e.g., RAM, ROM, or the like). The memory 248 can also include one or more cache memory devices, one or more buffers, one or more flash memory devices, or a combination thereof Computer storage media includes volatile and non-volatile, removable and non-removable media implemented in any method or technology for storage of information, such as computer readable instructions, data structures, program modules, or other data. Additionally, computer storage media includes, but is not limited to, random access memory (RAM), read only memory (ROM), electrically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media can embody computer readable instructions, data structures, program modules, or other data in a modulated data signal, such as a carrier wave. As defined herein, computer storage media does not include communication media.

The apparatus 244 can also include one or more additional components 250. For example, the one or more additional components 250 can include one or more input/output devices, such as a keyboard, a mouse, a touch screen, a display, speakers, a microphone, a camera, combinations thereof, and the like. The one or more additional components 250 can also include one or more communication interfaces for exchanging data with other devices, such as via a network, direct connection, or the like. For example, the communication interfaces can facilitate communications within a wide variety of networks or connections, such as one or more wired networks or wired connections and/or one or more wireless networks or wireless connections.

In an illustrative implementation, the control system 244 can obtain data that represents an image that is to be reproduced on the substrate 202. The data can be obtained via a network, such as a wired network or a wireless network. The data can also be obtained from the memory 248 or a memory device coupled to the apparatus 200. The control system 244 can utilize the data to generate commands to regulate the movement of the first housing 210, the second housing 232, or both to reproduce the image. In particular, the commands can cause the first non-magnetic ink printing component 218 to dispense an aqueous ink onto the first surface 206, the second non-magnetic ink printing component 234 to dispense the aqueous ink onto the second surface 208, or both. The commands can cause characters, such as letter, symbols, numbers, etc. to be printed onto one or more sides of the substrate 202. The commands can also cause pictures to be printed onto one or more sides of the substrate 202.

Additionally, the control system 244 can generate commands to cause the first magnetic ink component 214 to dispense a magnetic ink onto the first surface 206, the second magnetic ink component 236 to dispense magnetic ink onto the second surface 208, or both. In a particular implementation, the commands can cause the first magnetic ink component 214 and/or the second magnetic ink component 236 to dispense a magnetic material onto the substrate 202, such that the magnetic material can be arranged in a plurality of sections on the first surface 206, the second surface 208, or both. The plurality of sections can have a common shape, such as a circular shape, a rectangular shape, or a square shape, and be spaced at substantially regular intervals.

Further, the control system 244 can generate commands to cause the first magnetizing device 216 to move across the first surface 206 to apply a magnetic field to portions of the first surface 206 that include a magnetic material. The control system 244 can also generate commands to cause the second magnetizing device 238 to move across the second surface 208 to apply a magnetic field to portions of the second surface 208 that include a magnetic material. Applying a magnetic field to portions of the substrate 202 that include magnetic material can cause the portions of magnetic material to be aligned in a particular manner. Thus, the magnetized portions of the magnetic material disposed on a surface of the substrate 202 can be attracted to or repelled by a magnetic field depending on the polarity of the magnetic field experienced by the portions of magnetic material disposed on the substrate 202. In some cases, not all of the portions of magnetic material disposed on the substrate 202 may be magnetized. In addition, the commands to the first magnetizing device 216 and the second magnetizing device 238 can be directed to an intensity of the magnetic field generated, a time that the magnetic field is generated, or both. For example, commands sent to the first magnetizing device 216 can specify that current is to be applied to a magnetic component of the first magnetizing device 216 for a specified period of time to generate a magnetic field during that time. In addition, an amount of current to be applied to the magnetic component of the first magnetizing device 216 can also be specified by the commands.

FIG. 3 illustrates an example device 300 to magnetize magnetic material disposed on a surface 302 of a substrate 304 in a direction perpendicular to the surface 302 of the substrate 304. An amount of magnetic material 306 can be disposed on the surface 302 of the substrate 304. The magnetic material 306 has not been magnetized. That is, the particles of the magnetic material 306 have not been aligned.

The device 300 can include a first magnetic component 308 that includes a first coil 310 that is disposed around a first support member 312 and that includes a first magnetic plate 314. The device 300 can also include a second magnetic component 316 that includes a second coil 318 that is disposed around a second support member 320 and that includes a second magnetic plate 322. Optionally, the first support member 312 and the second support member 320 can be connected to form a single support member illustrated as yoke 324, which can stabilize and reinforce a magnetic field produced by the device 300. In an example implementation, the first magnetic component 314 can correspond to the first magnetic component 222 of FIG. 2 and the second magnetic component 322 can correspond to an additional magnetic component of the second magnetizing device 238 of FIG. 2.

A first current 326 can be applied in a first direction indicated by the arrow of 326 to the first coil 310 and a second current 328 can be applied in a second direction indicated by the arrow of 328 to the second coil 318 of the device 300. The first current 326 in the first coil 310 and the second current 328 current in the second coil 318 can be applied to cause the first magnetic plate 314 and the second magnetic plate 322 to have opposite magnetic polarities. In a particular implementation, by applying the first current 326 and the second current 328 in the directions indicated in FIG. 3, a magnetic field is produced in the direction 330 from the first magnetic plate 314 to the second magnetic plate 322. For example, by applying the first current 326 and the second current 328 to the first coil 310 and the second coil 318 and creating the magnetic field, the first magnetic plate 314 can have a first polarity and the second magnetic plate 322 can have a second polarity that is opposite the first polarity. In an illustrative implementation, the first magnetic plate 314 can be a north pole and the second magnetic plate 322 can be a south pole.

When the magnetic field 330 is applied to the magnetic material 306, the magnetic material 306 becomes a magnetized material 332. In particular, the particles of the magnetized material 332 can be aligned according to the direction of the magnetic field produced between the first magnetic plate 314 and the second magnetic plate 322 by applying the first current 326 to the first coil 310 and applying the second current 328 to the second coil 318. To illustrate, a first portion of magnetic particles 334 becomes disposed in a first direction and has a polarity opposite the polarity of the first magnetic plate 314. Additionally, a second portion of magnetic particles 336 becomes disposed in a second direction and has a polarity opposite the polarity of the second magnetic plate 322. Thus, the first portion of magnetic particles 334 has the same polarity as the second magnetic plate 322 and the second portion of magnetic particles 336 has the same polarity as the first magnetic plate 314. In the illustrative example of FIG. 3, the first portion of magnetic particles 334 and the second magnetic plate 322 have a south pole and the second portion of magnetic particles 336 and the first magnetic plate 314 have a north pole. In implementations where the first portion of the magnetic particles 334 have a south pole, additional magnetic materials having a north pole will be attracted to the substrate 304 and additional magnetic materials having a south pole will be repelled by the substrate 304.

In other implementations, current can be applied to the first coil 310 and the second coil 318 in a direction opposite the directions 326, 328. In these implementations, the first magnetic plate 314 can be a south pole and the second magnetic plate 322 can be a north pole. Additionally, the magnetized material 332 can be aligned such that the first portion of the magnetic particles 332 have a north pole and the second portion of the magnetic particles 334 can have a south pole.

FIG. 4 illustrates an example device 400 to magnetize material disposed on a surface 402 of a substrate 404 in a direction parallel to the surface 402 of the substrate 404. An amount of magnetic material 406 can be disposed on the surface 402 of the substrate 404. The magnetic material 406 has not been magnetized. That is, the particles of the magnetic material 406 have not been aligned.

The device 400 can include a magnetic component 408 that includes a coil 410 that is disposed around a support member 412. The device 408 also includes a first magnetic plate 414 and a second magnetic plate 416. A current 418 can be applied to the coil 410 of the device 408 to cause the first magnetic plate 414 and the second magnetic plate 416 to have opposite magnetic polarities. In a particular implementation, by applying the current 418, a magnetic field is produced in the direction 420 from the first magnetic plate 414 to the second magnetic plate 416. In an implementation, by applying the current 418 and creating the magnetic field, the first magnetic plate 414 can have a first polarity and the second magnetic plate 416 can have a second polarity that is opposite the first polarity. In an illustrative implementation, the first magnetic plate 414 can be a north pole and the second magnetic plate 416 can be a south pole.

When the magnetic field is applied to the magnetic material 406, the magnetic material 406 becomes a magnetized material 422. In particular, the particles of the magnetized material 422 can be aligned according to the direction of the magnetic field produced between the first magnetic plate 414 and the second magnetic plate 416 by applying the current 418 through the coil 410. To illustrate, a first portion of magnetic particles 424 becomes disposed in a first direction and has a polarity opposite the polarity of the first magnetic plate 414. Additionally, a second portion of magnetic particles 426 becomes disposed in a second direction and has a polarity opposite the polarity of the second magnetic plate 416. Thus, the first portion of magnetic particles 424 has the same polarity as the second magnetic plate 416 and the second portion of magnetic particles 426 has the same polarity as the first magnetic plate 414. In the illustrative example of FIG. 4, the first portion of magnetic particles 424 and the second magnetic plate 416 can have a south pole and the second portion of magnetic particles 426 and the first magnetic plate 414 can have a north pole. In implementations where the first portion of the magnetic particles have a south pole, additional magnetic materials having a north pole will be attracted to the substrate 404 and additional magnetic materials having a south pole will be repelled by the substrate 404.

In other implementations, current can be applied to the coil 410 in a direction opposite the direction of the current 418. In these implementations, the first magnetic plate 414 can be a south pole and the second magnetic plate 416 can be a north pole. Additionally, the magnetized material 422 can be aligned such that the first portion of the magnetic particles 424 have a north pole and the second portion of the magnetic particles 426 can have a south pole.

FIG. 5 illustrates a substrate 500 including a first region 502 having a layer of magnetic ink that is disposed substantially continuously in the first region 502 and a second region 504 having magnetic ink that is disposed in a plurality of sections at regular intervals and having a common shape. In particular, FIG. 5 includes a top view 506 of the substrate 500. As shown in the top view 506, the second region 504 includes a first section 508 of magnetic ink and a second section 510 of magnetic ink. Also, in the illustrative implementation of FIG. 5, the sections of magnetic ink included in the second region 504 have a circular shape, but in other implementations, the sections of magnetic ink can have a different shape. For example, the sections of magnetic ink included in the second region 504 can have a square shape, a rectangular shape, or an ellipsoidal shape.

FIG. 5 also includes a cross-sectional view 512 of the first region 502. The first region 502 can include a first portion of magnetic particles 514 having a first polarity and a second portion of magnetic particles 516 having a second polarity that is opposite the first polarity. The first portion of magnetic particles 514 can be disposed adjacent to the second portion of magnetic particles 516. Additionally, the layer of magnetic ink of the first region 502 can have a dimension 518. In implementations where the layer of magnetic ink of the first region 502 is square or rectangular, the dimension 518 can be a width. In other implementations where the layer of magnetic ink of the first region 502 has a circular shape, the dimension 518 can be a diameter. A magnetic field can be produced at the boundaries of the layer of magnetic ink of the first region 502 indicated by 520 and 522.

Further, FIG. 5 includes a cross-sectional view 524 of the second region 504. The plurality of sections of the second region 504 can each have a first portion of magnetic particles 526 having a first polarity and a second portion of magnetic materials 528 adjacent to the first portion of magnetic materials 520. The second portion of magnetic materials 528 can have a second polarity that is opposite the first polarity. The sections of magnetic ink included in the second region 504 can have one or more dimensions. For instance, in the illustrative example of FIG. 5, the first section 506 has a dimension 530. In implementations where the sections of the second region 504 are square or rectangular, the dimension 530 can be a width. In other implementations where the sections of the second region 504 have a circular shape, the dimension 530 can be a diameter.

Additionally, there can be a space between the sections of the second region 504. In some cases, the space between the sections of the second region 504 can have substantially the same value. In this way, the plurality of sections of the second region 504 can be spaced at substantially regular intervals. In the illustrative example of FIG. 5, a space 532 can be disposed between the first section 508 and the second section 510. Furthermore, although the space 532 is shown as the distance between a boundary of the first section 508 and a boundary of the second section 510, in other situations, the space 532 can be represented by the distance between a center of the first section 508 and a center of the second section 510. In an implementation, the space 532 can be no greater than about 5 mm, no greater than about 3 mm, no greater than about 2 mm, or no greater than about 1 mm. The space 532 can also be at least about 0.01 mm, at least about 0.05 mm, at least about 0.1 mm, at least about 0.2 mm, at least about 0.5 mm, or at least about 0.7 mm. In an illustrative example, the space 532 can be included in a range of about 0.005 mm to about 10 mm. In another illustrative example, the space 532 can be included in a range of about 0.2 mm to about 2 mm. In an additional illustrative example, the space 532 can be included in a range of about 0.3 mm to about 0.8 mm.

The plurality of sections of magnetic ink included in the second region 504 can also have a greater number of sections of magnetic ink or fewer sections of magnetic ink than the number shown in FIG. 5. In some cases, a concentration of sections of magnetic ink included in a region of a substrate can be defined as a percent of a ratio of a surface area of the region that includes sections of magnetic ink with respect to a total surface area of the region. In an implementation, the percent of the ratio of a surface area of the region that includes sections of magnetic ink with respect to a total surface area of the region can be no greater than about 90%, no greater than about 85%, no greater than about 80%, no greater than about 75%, no greater than about 70%, no greater than about 65%, or no greater than about 60%. Additionally, the percent of the ratio of a surface area of the region that includes sections of magnetic ink with respect to a total surface area of the region can be at least about 20%, at least about 25%, at least about 30%, at least about 35%, at least about 40%, at least about 45%, at least about 50%, or at least about 55%. In an illustrative example, the percent of the ratio of a surface area of the region that includes sections of magnetic ink with respect to a total surface area of the region can be included in a range of about 15% to about 95%. In another illustrative example, the percent of the ratio of a surface area of the region that includes sections of magnetic ink with respect to a total surface area of the region can be included in a range of about 30% to about 70%. In an additional illustrative example, the percent of the ratio of a surface area of the region that includes sections of magnetic ink with respect to a total surface area of the region can be included in a range of about 40% to about 60%. In a further illustrative example, the percent of the ratio of a surface area of the region that includes sections of magnetic ink with respect to a total surface area of the region can be included in a range of about 50% to about 75%. In yet another illustrative example, the percent of the ratio of a surface area of the region that includes sections of magnetic ink with respect to a total surface area of the region can be included in a range of about 30% to about 50%. In a still further illustrative example, the percent of the ratio of a surface area of the region that includes sections of magnetic ink with respect to a total surface area of the region can be included in a range of about 60% to about 80%.

A magnetic field can be produced at the boundaries of individual sections of the second region 504. In some cases, a magnetic field can be produced on each end of each section of the second region 504. For example, a magnetic field indicated by 534 and by 536 can be produced at the boundaries of the first section 508. The total magnetic field generated by the second region 504 can be greater than the total magnetic field generated by the first region 502. In particular, the total magnetic field produced by the second region 504 is a combination of the magnetic fields produced by the individual sections of the second region 504. In contrast, the total magnetic field produced by the first region 502 is mostly a combination of the magnetic fields produced at the ends of the layer of magnetic ink of the first region 502. By producing a magnetic field at the boundaries of individual sections of magnetic ink included in a particular region, the strength of the magnetic field of the region can be increased. Thus, the strength of the attractive or repelling forces of the region are also increased.

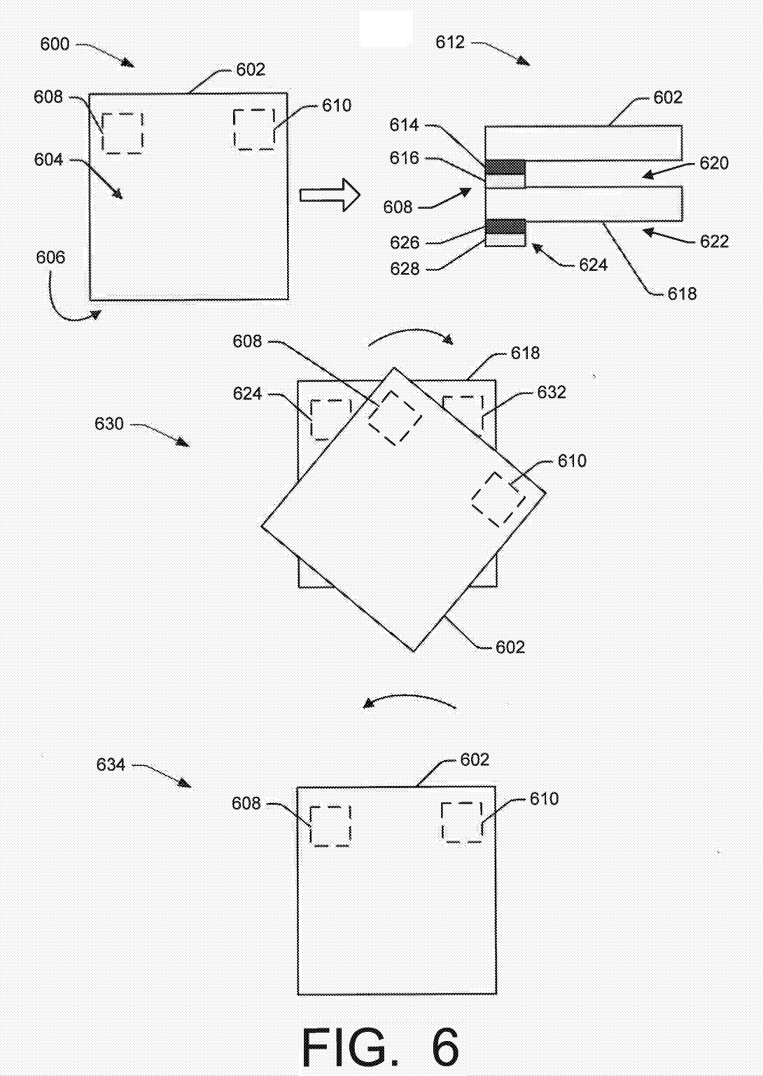

FIG. 6 illustrates a number of substrates that include portions of magnetic ink disposed on surfaces of the substrates and that have a magnetic force. In an implementation, FIG. 6 includes a first top view 600 of a plurality of substrates having magnetic ink disposed on a respective surface of the plurality of substrates. The top view 600 includes a first substrate 602 that includes a first surface 604 and a second surface 606 that is opposite to the first surface 604 and parallel to the first surface 604. A first portion of magnetic ink 608 and a second portion of magnetic ink 610 can be disposed on the second surface 606 of the first substrate 602.

FIG. 6 also includes a side view 612 of the plurality of substrates. In particular, the side view 612 shows that the first portion of magnetic ink 608 includes a first portion of magnetic particles 614 and a second portion of magnetic particles 616 disposed on the second side 606 of the first substrate 602. The first portion of magnetic particles 614 can have a first polarity and the second portion of magnetic particles 616 can have a second polarity that is opposite the first polarity. The side view 612 also shows a second substrate 618 that includes a first surface 620 and a second surface 622 that is opposite to the first surface 620 and parallel to the first surface 620. A third portion of magnetic ink 624 can be disposed on the second surface 622 of the second substrate 618. The third portion of magnetic ink 624 disposed on the second side of the second substrate 618 includes a third portion of magnetic particles 626 and a fourth portion of magnetic particles 628. The third portion of magnetic particles 626 can have a first polarity and the fourth portion of magnetic particles 628 can have a second polarity that is opposite the first polarity. The illustrative example of FIG. 6 shows portions of magnetic particles having opposite polarities disposed in a direction perpendicular to the respective surface on which the portions of magnetic particles are disposed. To illustrate, the first portion of magnetic particles 614 and the second portion of the magnetic particles 616 can be disposed in a direction perpendicular to the second surface 606 of the first substrate 602 and the third portion of magnetic particles 626 and the fourth portion of magnetic particles 628 can be disposed in a direction perpendicular to the second surface 622 of the second substrate 618.

In the illustrative example of FIG. 6, the first portion of magnetic particles 614 can have the same polarity as the third portion of magnetic particles 626 and the second portion of magnetic particles 616 can have the same polarity as the fourth portion of magnetic particles 628. Thus, the second portion of magnetic particles 616 of the first substrate 602 has an opposite polarity of the third portion of magnetic particles 626 of the second substrate 618 Accordingly, the second portion of magnetic particles 616 can be attracted to the third portion of magnetic particles 626 and the first substrate 602 and the second substrate 618 can be coupled together via the magnetic fields of the second portion of magnetic particles 616 and the third portion of magnetic particles 626.

Additionally, FIG. 6 includes a second top view 630 of the plurality of substrates having portions of magnetic ink disposed on respective surfaces of the plurality of substrates. In particular, the second top view 630 includes the first substrate 602 having the first portion of magnetic ink 608 and the second portion of magnetic ink 610. Additionally, the second top view 630 includes the second substrate 618 having the third portion of magnetic ink 624 and a fourth portion of magnetic ink 632. Further, in the illustrative example shown by the second top view 630 of FIG. 6, the first substrate 602 has been moved from a first position shown in the first top view 600 to a second position shown in the second top view 630. In particular, the first substrate 602 has been rotated in a clockwise direction with respect to the second substrate 618. Thus, the first substrate 602 and the second substrate 618 are no longer aligned as in the first top view 600 and the side view 612. Accordingly, portions of the second substrate 618 are visible in the second top view 630.

Furthermore, FIG. 6 includes a third top view 634 of the plurality of substrates having portions of magnetic ink disposed on respective surfaces of the plurality of substrates. In the third top view 634, the first substrate 602 has been moved in a counterclockwise direction from the position shown in the second top view 630 by the attractive magnetic forces of the portions of magnetic material disposed on the second side 606 of the first substrate 602 and the portions of magnetic material disposed on the second side 622 of the second substrate 618. Consequently, the first substrate 602 is again aligned with the second substrate 618 as in the first top view 600.

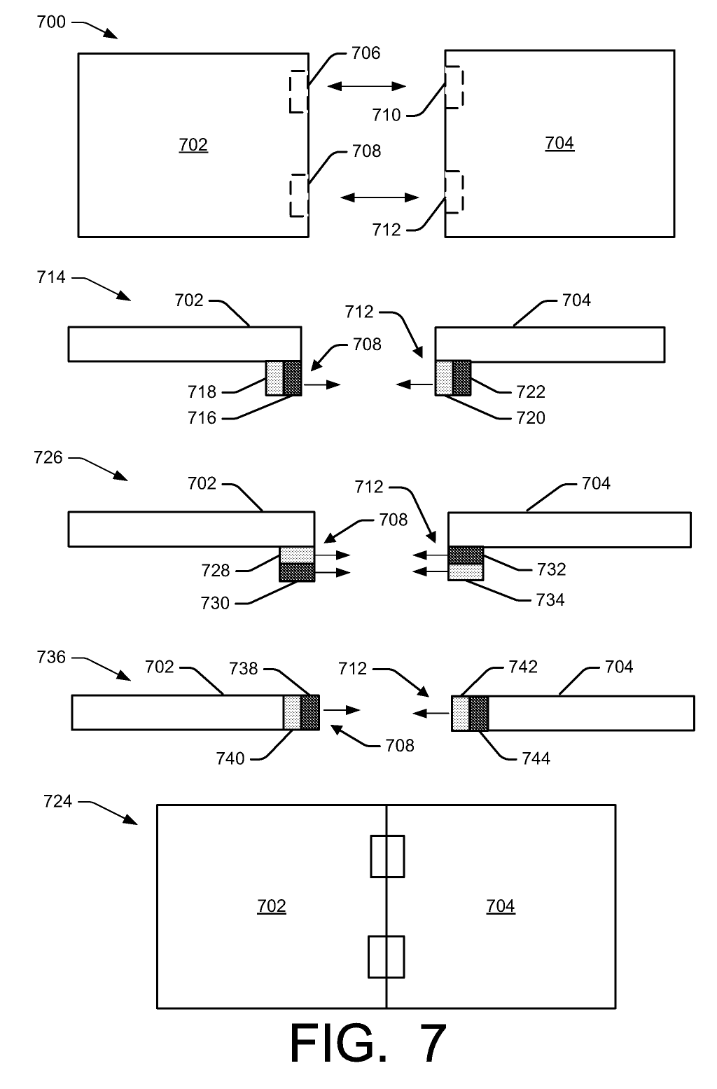

FIG. 7 illustrates a number of substrates that include portions of magnetic ink disposed on surfaces of the substrates and that have a magnetic force. The illustrative example of FIG. 7 can include a first top view 700 of a first substrate 702 and a second substrate 704. The first substrate 702 can include a first portion of magnetic ink 706 and a second portion of magnetic ink 708. Additionally, the second substrate 704 can include a third portion of magnetic ink 710 and a fourth portion of magnetic ink 712. In the illustrative example of FIG. 7, the first portion of magnetic ink 706 and the third portion of magnetic ink 710 can be attracted to each other. Additionally, the second portion of magnetic ink 708 and the fourth portion of magnetic ink 712 can be attracted to each other.

FIG. 7 also shows a first side view 714 of the first substrate 702 and the second substrate 704. The first side view 714 shows that the second portion of magnetic ink 708 of the first substrate 702 can include a first portion of magnetic particles 716 and a second portion of magnetic particles 718. The first portion of magnetic particles 716 can have a polarity that is opposite a polarity of the second portion of magnetic particles 718. Additionally, the first side view 714 shows that fourth portion of magnetic ink 712 of the second substrate 704 can include a third portion of magnetic particles 720 and a fourth portion of magnetic particles 722. The third portion of magnetic particles 720 can have a polarity that is opposite a polarity of the fourth portion of magnetic particles 722.

In the illustrative example of the first side view 714 of FIG. 7, the first portion of magnetic particles 716 and the fourth portion of magnetic particles 722 can have a first polarity and the second portion of magnetic particles 718 and the third portion of magnetic particles 720 can have a second polarity that is opposite the first polarity. The first portion of magnetic particles 716 and the third portion of magnetic particles 720 can have an opposite polarity and be attracted to each other. In this way, the first substrate 702 and the second substrate 704 can be coupled to each other through the magnetic fields of the first portion of magnetic particles 716 and the third portion of magnetic particles 720 as shown in the second top view 724 of FIG. 7.

In addition, FIG. 7 shows a second side view 726 of the first substrate 702 and the second substrate 704 having an additional arrangement of magnetic particles that can be used to couple the first substrate 702 and the second substrate 704. For example, the first side view 716 shows that the second portion of magnetic ink 708 of the first substrate 702 can include a fifth portion of magnetic particles 728 and a sixth portion of magnetic particles 730. The fifth portion of magnetic particles 728 can have a polarity that is opposite a polarity of the sixth portion of magnetic particles 730. Additionally, the second side view 726 shows that fourth portion 712 of the second substrate 704 can include a seventh portion of magnetic particles 732 and an eighth portion of magnetic particles 734. The seventh portion of magnetic particles 732 can have a polarity that is opposite a polarity of the eighth portion of magnetic particles 734. In the second side view 726, the fifth portion of magnetic particles 728 and the seventh portion of magnetic particles 732 can be attracted to each other and the sixth portion of magnetic particles 730 and the eighth portion of magnetic particles 734 can be attracted to each other to couple the first substrate 702 to the second substrate 704.

Further, FIG. 7 shows a third side view 736 of the first substrate 702 and the second substrate 704 having a different arrangement of magnetic particles that can be used to couple the first substrate 702 and the second substrate 704. In particular, the second portion of magnetic ink 708 is disposed at an edge of the first substrate 702 and the fourth portion of magnetic ink 712 is disposed at an edge of the second substrate 704. The third side view 736 shows that the second portion of magnetic ink 708 of the first substrate 702 can include a ninth portion of magnetic particles 738 and a tenth portion of magnetic particles 740. The ninth portion of magnetic particles 738 can have a polarity that is opposite a polarity of the tenth portion of magnetic particles 740. Additionally, the third side view 736 shows that the fourth portion 712 of the second substrate 704 can include an eleventh portion of magnetic particles 742 and a twelfth portion of magnetic particles 744. The eleventh portion of magnetic particles 742 can have a polarity that is opposite a polarity of the twelfth portion of magnetic particles 744. In the third side view 736, the ninth portion of magnetic particles 738 and the eleventh portion of magnetic particles 742 can be attracted to each other to couple the first substrate 702 to the second substrate 704.

Additionally, the illustrative example of FIG. 7 shows portions of magnetic particles having opposite polarities disposed in a direction parallel to the respective surface on which the portions of magnetic particles are disposed. To illustrate, the first portion of magnetic particles 716 and the second portion of the magnetic particles 718 can be disposed in a direction parallel to the surface of the first substrate 702 on which the magnetic particles are disposed. Furthermore, the third portion of magnetic particles 720 and the fourth portion of magnetic particles 722 can be disposed in a direction parallel to the surface of the second substrate 704 on which the magnetic particles are disposed. The illustrative example of FIG. 7 also shows portions of magnetic particles having opposite polarities disposed in a direction perpendicular to the respective surface on which the portions of magnetic particles are disposed. For example, the fifth portion of magnetic particles 728 and the sixth portion of magnetic particles 730 can be disposed in a direction perpendicular to the surface of the first substrate 702 on which the magnetic particles are disposed. Additionally, the seventh portion of magnetic particles 732 and the eighth portion of magnetic particle 734 can be disposed in a direction perpendicular to the surface of the second substrate 704 on which the magnetic particles are disposed.

Although the illustrative example of FIG. 7 shows that the first substrate 702 includes two portions of magnetic ink disposed along a single edge and that the second substrate 704 includes two portions of magnetic ink disposed along a single edge, the first substrate 702 and the second substrate 704 can include a different number of portions of magnetic ink disposed along a single edge. Furthermore, the first substrate 702 and the second substrate 704 can include portions of magnetic ink disposed along multiple edges.

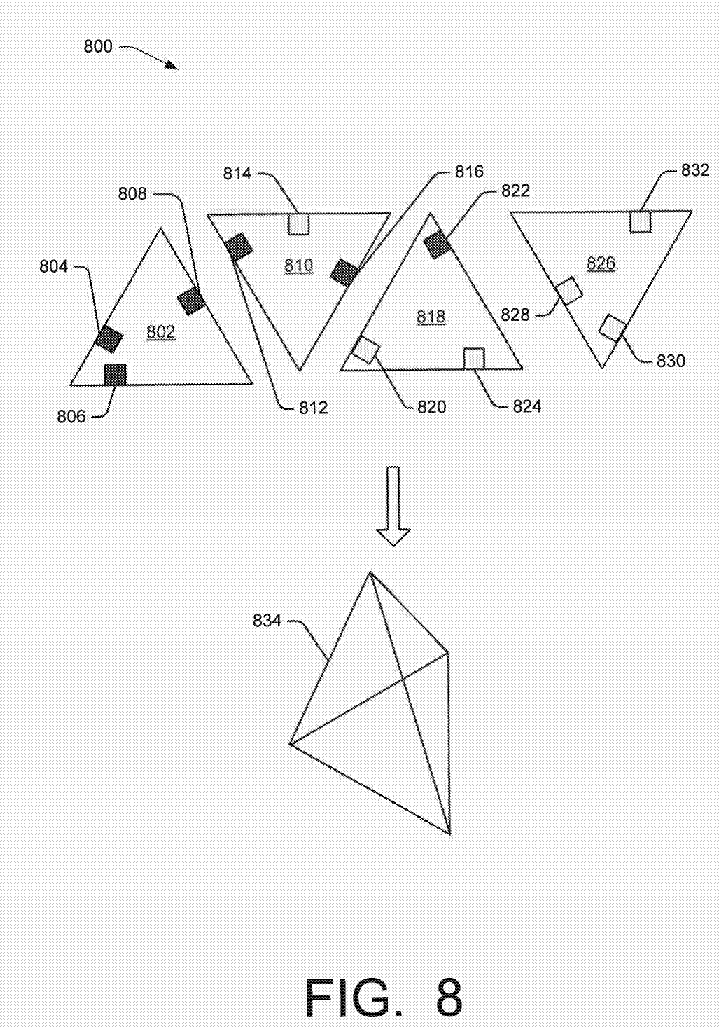

FIG. 8 illustrates a number of substrates that include portions of magnetic ink disposed on surfaces of the substrates and that have magnetic fields disposed on the substrates to cause the number of substrates to align to form an object. FIG. 8 includes a top view 800 of a plurality of substrates including portions of magnetic ink. In an implementation, the top view 800 includes a first substrate 802 having a first portion of magnetic ink 804, a second portion of magnetic ink 806, and a third portion of magnetic ink 808. Additionally, the top view 800 includes a second substrate 810 having a fourth portion of magnetic ink 812, a fifth portion of magnetic ink 814, and a sixth portion of magnetic ink 816. Furthermore, the top view 800 includes a third substrate 818 having a seventh portion of magnetic ink 820, an eighth portion of magnetic ink 822, and a ninth portion of magnetic ink 824. The top view 800 also includes a fourth substrate 826 having a tenth portion of magnetic ink 828, an eleventh portion of magnetic ink 830, and a twelfth portion of magnetic ink 832.

The portions of magnetic ink on the substrates 802, 810, 818, and 826 can have polarities that are arranged in such a way to cause magnetic fields of the portions of magnetic ink to be attracted to each other to form an object. For example, the portions of magnetic ink 804, 806, 808, 812, 816, and 822 can produce a magnetic field having a first polarity and portions of magnetic ink 814, 820, 824, 828, 830, and 832 can produce a magnetic field having a second polarity that is opposite the first polarity. In an illustrative implementation, when the substrates 802, 810, 818, and 826 are brought into proximity to one another and the portions of magnetic ink disposed on the substrates 802, 810, 818, and 826 that have opposite polarities are arranged adjacent to one another, the attractive forces produced by the magnetic fields of the portions of magnetic ink on the substrates 802, 810, 818, and 826 can cause the substrates 802, 810, 818, and 826 to come together to form an object 834.

By properly arranging the portions of magnetic ink and also the respective polarities of the portions of magnetic ink, particular connections between the connections are produced, while other connections are precluded based on the arrangement of the portions of magnetic ink and their respective polarities. Thus, attractive forces are produced with respect to specific portions of magnetic ink in order to form the object 834. In addition, the portions of magnetic ink at the edges of the substrates 802, 810, 818, 826 can provide a “hinged joint” between two substrates connected each other.

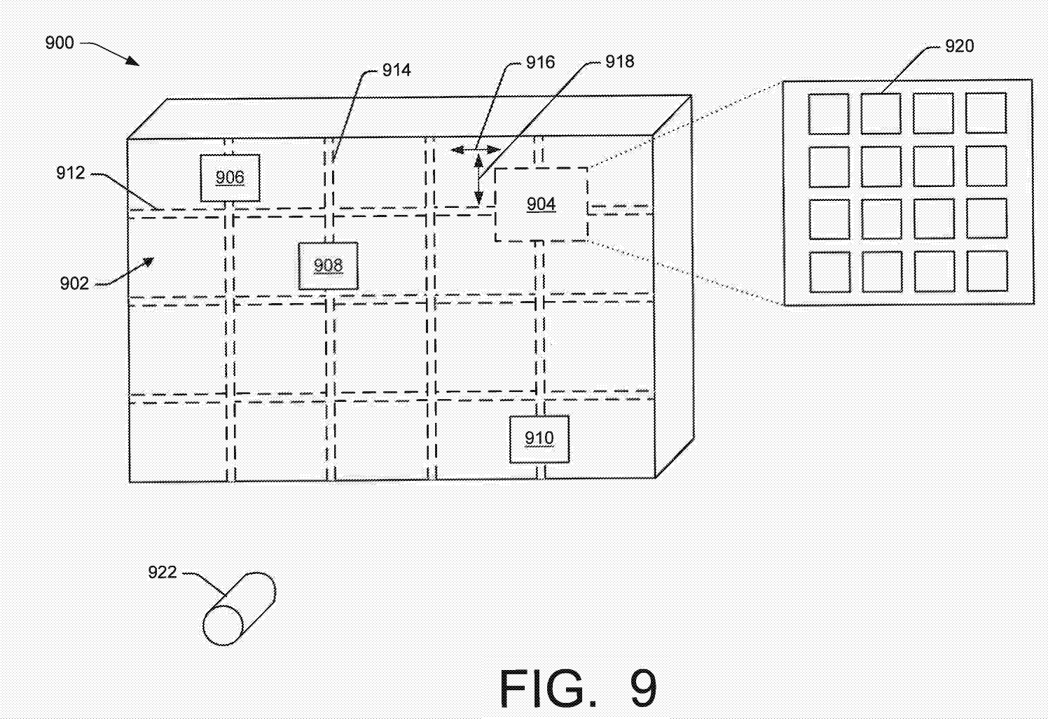

FIG. 9 illustrates an apparatus 900 having a surface 902 and including a magnetic device 904 to move substrates coupled to the surface 902 of the apparatus 900 from a first location on the surface 902 to a second location on the surface 902. The magnetic device 904 can be disposed behind the surface 902 of the apparatus 900. In an implementation, a first substrate 906 can attached to the surface 902. Additionally, a second substrate 908 can be attached to the surface 902 and a third substrate 910 can be attached to the surface 902. In some cases, the first substrate 906, the second substrate 908, and the third substrate 910 can be attached to the surface 902 by adhesive disposed on at least a portion of a surface of the first substrate 906 adjacent to the surface 902, adhesive disposed on at least a portion of a surface of the second substrate 908 adjacent to the surface 902, and adhesive disposed on at least a portion of a surface of the third substrate 910 adjacent to the surface 902.

The apparatus 900 can also include one or more horizontally arranged rails, such as a first rail 912 and one or more vertically arranged rails, such as a second rail 914. The one or more horizontally arranged rails and the one or more vertically arranged rails can be disposed behind the surface 902. The magnetic device 904 can be attached to the horizontally arranged rails and the vertically arranged rails such that the magnetic device 904 can move in directions indicated by a first arrow 916 and in directions indicated by a second arrow 918. In this way, the magnetic device 904 can move to a location where a substrate is located, such as a location of the first substrate 906, a location of the second substrate 908, and a location of the third substrate 910.

The magnetic device 904 can include one or more motors, one or more belts, one or more microcontrollers, or a combination thereof, to move the magnetic device 904 along the horizontally arranged rails and the vertically arranged rails of the apparatus 900. The magnetic device 904 can also include a plurality of magnetic components, such as a representative magnetic component 920. The magnetic component 920 can be a magnet that has a particular polarity. In some cases, the magnetic component 920 can be a north pole. In other cases, the magnetic component 920 can be a south pole. In an implementation, the magnetic component 920 can be activated when current is caused to flow through one or more coils of the magnetic device 904.

The apparatus 900 can include or be coupled to a camera 922. The camera 922 can capture images of substrates attached to the surface 902 of the apparatus 900. The images of the substrates captured by the camera 922 can be used to determine a location of the substrates. For example, an image that includes a housing of the apparatus 900, the first substrate 906, the second substrate 908, and a third substrate 910 can determine a location of the first substrate 906 on the surface 902, a location of the second substrate 908 on the surface 902, and a location of the third substrate 910 on the surface 902 through the use of image recognition techniques and information about dimensions of the housing and the substrates 906, 908, 910. The location of a substrate can be expressed as a coordinate pair or using distance from a reference point, such as a center of the surface 902 or an edge of the surface 902. Additionally, an image of the first substrate 906 can be used to determine content of the first substrate 906. To illustrate, image recognition techniques can be used to determine content of the first substrate 906. Correspondingly, an image of the second substrate 908 can be used to determine content of the second substrate 908 and an image of the third substrate can be used to determine content of the third substrate 910.

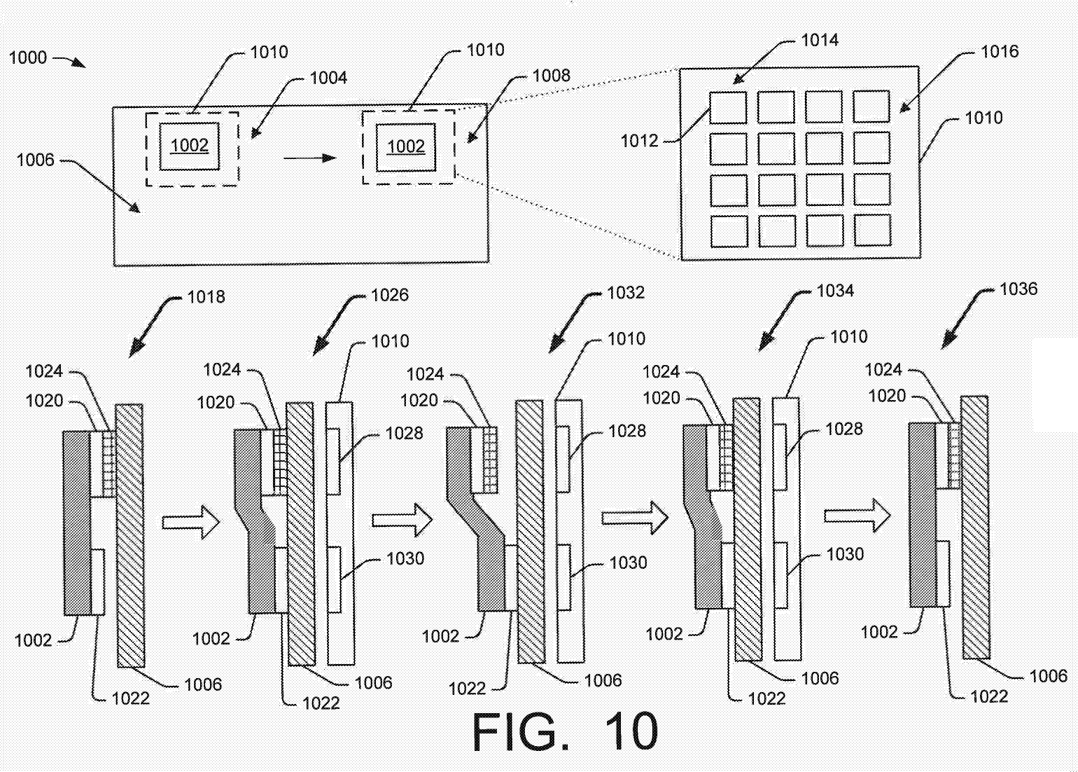

FIG. 10 illustrates an apparatus 1000 where magnetic forces can be applied to different portions of a substrate 1002 to move the substrate 1002 from a first location 1004 on a surface 1006 of the apparatus 1000 to a second location 1008 on the surface 1006 of the apparatus 1000. The apparatus 1000 can include a magnetic device 1010 to move the substrate 1002 from the first location 1004 to the second location 1008. In an implementation, the magnetic device 1010 can include a plurality of magnetic components, such as a representative magnetic component 1012. In an illustrative implementation, the magnetic components of the magnetic device 1010 can be arranged in a plurality of vertically arranged columns, such as a representative column 1014 and a plurality of horizontally arranged rows, such as a representative row 1016. In a particular implementation, the apparatus 1000 and the magnetic device 1010 can correspond to the apparatus 900 of FIG. 9 and the magnetic device 904 of FIG. 9 and the substrate 1002 can correspond to one of the first substrate 906, the second substrate 908, or the third substrate 910 of FIG. 9.

The illustrative example of FIG. 10 can include a first side view 1018 including the substrate 1002 and the surface 1006 of the apparatus 1000 at a first time. As shown in the first side view 1018, the substrate 1002 can include a first magnetic ink portion 1020 and a second magnetic ink portion 1022. The first magnetic ink portion 1020 and the second magnetic ink portion 1022 can include magnetic particles that can be attracted to other magnetic particles having a polarity that is opposite a polarity of at least a portion of the magnetic particles of the first magnetic ink portion 1020 and the second magnetic ink portion 1022. The substrate 1002 can also include an adhesive portion 1024. The adhesive portion 1024 can cause the substrate 1002 to be attached to the surface 1006 of the apparatus 1000.

The illustrative example of FIG. 10 can also include a second side view 1026 including the substrate 1002 and the surface 1006 of the apparatus 1000 at a second time. As shown in second side view 1026, the magnetic device 1010 can be moved into a location that is aligned with a location of the substrate 1002. The magnetic device 1010 can include a first magnetic component 1028 and a second magnetic component 1030. Additionally, a magnetic force can be produced to cause the second magnetic ink portion 1022 to be attracted to the second magnetic component 1030 of the magnetic device 1010. In an illustrative implementation, the magnetic device 1010 can be moved to the first location 1000 and current can then be applied to the magnetic device 1010, such that the second magnetic component 1030 is attracted to the second magnetic ink portion 1022. The second magnetic ink portion 1022 and the second magnetic component 1030 can be attracted to each other when magnetic particles of the second magnetic ink portion 1020 having a first polarity and magnetic particles of the second magnetic component 1030 having a second polarity opposite the first polarity are within a threshold distance.

Additionally, the illustrative example of FIG. 10 can include a third side view 1032 including the substrate 1002 and the surface 1006 of the apparatus 1000 at a third time. During the third time, current can be applied to the first magnetic component 1028 to repel the first magnetic ink portion 1020 of the substrate 1002. For example, current can be applied to the magnetic device 1010 such that magnetic particles of the first magnetic ink portion 1020 having a first polarity are repelled by magnetic particles of the first magnetic component 1028 that also have the first polarity when the magnetic ink particles of the first magnetic ink portion 1020 are within a threshold distance of the magnetic particles of the first magnetic component 1028 having the opposite polarity. In this way, the substrate 1002 can become detached from the surface 1006 when the magnetic force repelling the first magnetic ink portion 1020 from the first magnetic component 1028 is greater than the bond between the adhesive portion 1024 and the surface 1006. After detaching the substrate 1002 from the surface 1006, the magnetic device 1010 can move to the second location 1008. The substrate 1002 can also be moved to the second location 1008 by the magnetic device 1010 because the second magnetic ink portion 1022 is attracted to the second magnetic component 1030. Thus, as the magnetic device 1010 moves from the first location 1004 to the second location 1008, the substrate 1002 also moves from the first location 1004 to the second location 1008.

Further, the illustrative example of FIG. 10 can include a fourth side view 1034 including the substrate 1002 and the surface 1006 of the apparatus 1000 at a fourth time. During the fourth time, current can continue to be applied to the magnetic device 1010 to cause the second magnetic ink portion 1022 to be attracted to the second magnetic component 1030. Additionally, current can be applied to the magnetic device 1010 to cause the first magnetic ink portion 1020 to be attracted to the first magnetic component 1028. The first magnetic ink portion 1020 and the first magnetic component 1028 can be attracted to each other when magnetic particles of the first magnetic ink portion 1020 having a first polarity and magnetic particles of the second magnetic component 1028 having a second polarity opposite the first polarity are within a threshold distance. Also, the attractive magnetic forces between the first magnetic ink portion 1020 and the first magnetic component 1028 can be maintained for an amount of time for the adhesive portion 1024 to become affixed to the surface 1006 of the apparatus 1000.

The illustrative example of FIG. 10 can also include a fifth side view 1036 including the substrate 1002 and the surface 1006 of the apparatus 1000 at a fifth time. In a particular implementation, the current applied to the magnetic device 1010 at the third time and the fourth time can be removed and the first magnetic component 1028 and the second magnetic component 1030 may no longer have influence over the first magnetic ink portion 1020 and the second magnetic ink portion 1022. Thus, the magnetic device 1010 can be moved away from the second location 1008 to a different location. Additionally, the adhesive portion 1024 can be coupled to the surface 1006 at the second location 1008.

Although not shown in the illustrative example of FIG. 10, the magnetic device 1010 can be coupled to a control system, such as the control system 122 of FIG. 1 or the control system 244 of FIG. 2. The control system can send signals to the magnetic device 1010 to move the magnetic device 1010 to one or more locations on the surface 1006 of the apparatus 1000. Additionally, the control system can send signals to the magnetic device 1010 to cause current to flow through coils of the magnetic device 1010 to generate a magnetic field in one or more of the magnetic components of the magnetic device 1010. In this way, the magnetic device 1010 can cause magnetic materials to be attracted to or repelled by the magnetic components of the magnetic device 1010 depending on a polarity of the magnetic materials and a polarity of the magnetic field generated by the magnetic device 1010.

Additionally, although the illustrative example of FIG. 10 has been described with respect to moving the substrate 1002 from the first location 1004 to the second location 1008, the apparatus 1000 can have other applications. In one example, current can be applied to the magnetic device 1010 to cause magnetic ink portions of the substrate 1002 to be attracted to corresponding magnetic components of the magnetic device 1010. In this way, the removal of the substrate 1002 from the surface 1006 can be prevented or require more energy to remove the substrate 1002 from the surface 1006. In another example, current can be applied to the magnetic device 1010 in discrete pulses to cause the magnetic forces produced by the magnetic components to alternate between attractive forces and repelling forces. Thus, the substrate 1002 can have an appearance of waving, in some cases, or vibrating, in other cases, depending on a length of the pulses and the magnetic components that are exerting the magnetic forces. To illustrate, applying pulses of current to the first magnetic component 1028 and the second magnetic component 1030 can cause the substrate 1002 to vibrate. Alternatively, applying pulses of current to the second magnetic component 1030 and not the first magnetic component 1028 can cause the substrate 1002 to wave or flutter. In situations where more than two rows of magnetic components can exert magnetic forces on magnetic ink portions of the substrate 1002, current can be applied to the magnetic components to cause the substrate 1002 to curl toward a portion of the substrate 1002 attached to the surface 1006, such as by an adhesive. In an additional illustrative implementation, the first magnetic component 1028 and the second magnetic component 1030 can apply magnetic forces that repel the first magnetic ink portion 1020 and the second magnetic ink portion 1022 to remove the substrate 1002 from the surface 1006. In particular, once the magnetic forces repelling the first magnetic ink portion 1020 and the second magnetic ink portion 1024 from the surface 1006 are applied, gravity can cause the substrate 1002 to fall away from the substrate 1002.

Furthermore, although the side views 1018, 1026, 1032, 1034, and 1036 show a first magnetic ink portion 1020 and a second magnetic ink portion 1022 of the substrate 1002, the substrate 1002 can include additional magnetic ink portions that can be influenced by magnetic forces of additional magnetic components of the magnetic device 1010. Also, although the side views 1018, 1026, 1032, 1034, and 1036 show the first magnetic component 1028 and the second magnetic component 1030 producing magnetic forces that affect the substrate 1002, the first magnetic component 1028 can be one of a plurality of magnetic components in a first row of magnetic components that can affect the substrate 1002 and the second magnetic component 1030 can be one of a plurality of magnetic components in a second row of magnetic components that can affect the substrate 1002.

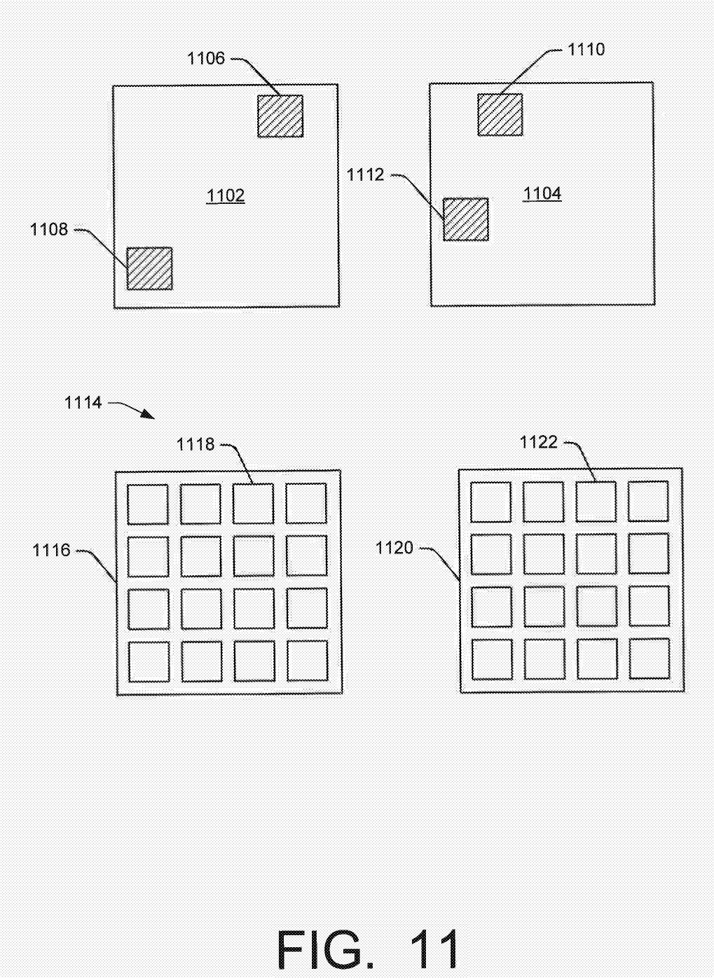

FIG. 11 illustrates an arrangement of a magnetic ink on a first substrate 1102, an arrangement of magnetic ink on a second substrate 1104, and magnetic devices including a number of magnetic components In the illustrative example of FIG. 11, the first substrate 1102 includes a first magnetic ink portion 1106 and a second magnetic ink portion 1108. Additionally, the second substrate 1102 includes a third magnetic ink portion 1110 and a fourth magnetic ink portion 1112. The first magnetic ink portion 1106, the second magnetic ink portion 1108, the third magnetic ink portion 1110, and the fourth magnetic ink portion 1112 can be magnetized and respond to the influence of a magnetic field. Further, the illustrative example of FIG. 11 includes an apparatus 1114 that can include a first magnetic device 1116 having one or more magnetic components, such as a first representative magnetic component 1118. In some cases, the apparatus 1106 can also include a second magnetic device 1120 having one or more magnetic components, such as a second representative magnetic component 1122. The magnetic components of the first magnetic device 1116 and the magnetic components of the second magnetic device 1120 can produce a magnetic field when current is applied to the first magnetic device 1116 and the second magnetic device 1120.

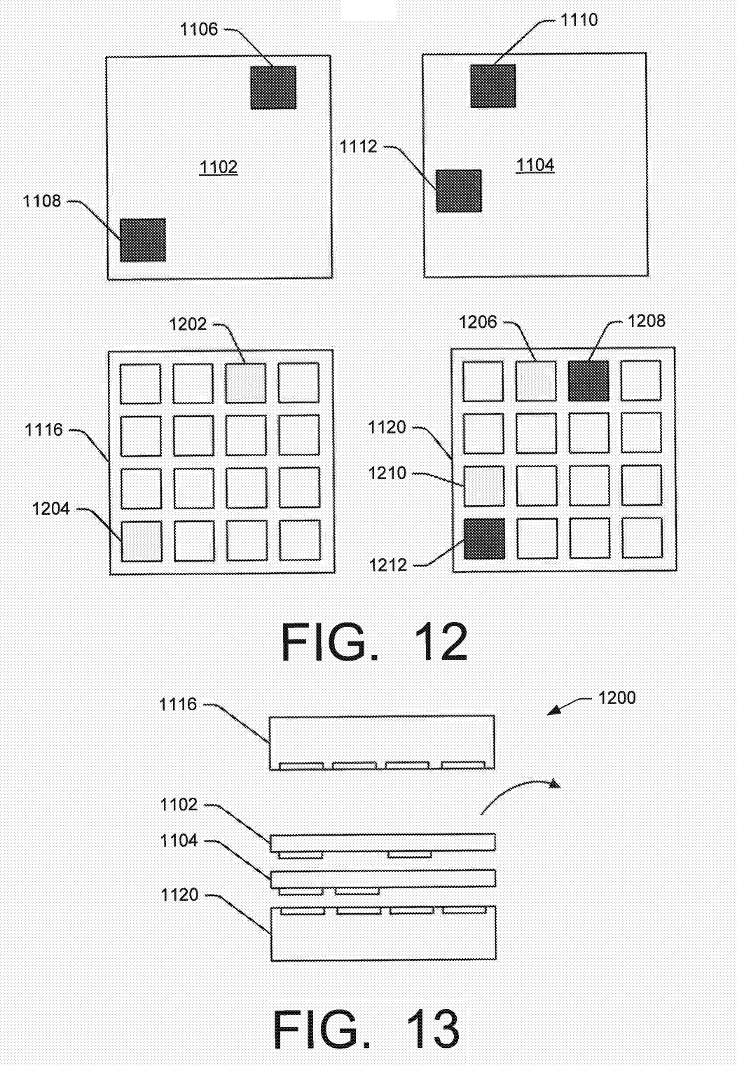

FIG. 12 illustrates a pattern of activating magnetic components of the first magnetic device 1116 and magnetic components of the second magnetic device 1120 of the apparatus 1100 of FIG. 11. For example, current can applied to the first magnetic device 1116 such that a magnetic field is produced by a first magnetic component 1202 and a second magnetic component 1204. The first magnetic component 1202 and the second magnetic component 1204 can be activated to have a first polarity. Additionally, current can be applied to the second magnetic device 1120 such that a magnetic field is produced by a third magnetic component 1206, a fourth magnetic component 1208, a fifth magnetic component 1210, and a sixth magnetic component 1212. The third magnetic component 1206 and the fifth magnetic component 1210 can be activated to have the first polarity, while the fourth magnetic component 1208 and the sixth magnetic component 1212 can be activated to have a second polarity that is opposite the first polarity. Furthermore, the magnetic ink portions 1106, 1108 of the first substrate 1102 and the magnetic ink portions 1110, 1112 of the second substrate 1104 can be magnetized to have the second polarity.

FIG. 13 illustrates selection of the first substrate 1102 according to attractive and repelling forces of magnetic components of the first magnetic device 1116 and the second magnetic device 1120 of the apparatus 1114 of FIG. 11. To illustrate, by applying the pattern of magnetic forces of FIG. 12 to the first magnetic device 1116 and the second magnetic device 1120, the magnetic forces of the first magnetic component 1202 and the second magnetic component 1204 attract the first magnetic ink portion 1106 and the second magnetic ink portion 1108. In addition, the magnetic forces of the third magnetic component 1206 and the fifth magnetic component 1210 of the second magnetic device 1120 can attract the third magnetic ink portion 1110 and the fourth magnetic ink portion 1112 of the second substrate 1108. Further, the magnetic forces of the fourth magnetic component 1208 and the sixth magnetic component 1212 can repel the first magnetic ink portion 1106 and the second magnetic ink portion 1108 of the first substrate 1102. In this way, the first substrate 1102 can be drawn toward the first magnetic device 1116 by the attractive magnetic forces generated by the first magnetic device 1116 and the repelling magnetic forces of the second magnetic device 1120. Also, the second substrate 1104 can be drawn toward the second magnetic device 1120. In this way, the second substrate 1104 can be coupled with the second magnetic device 1120, while the first substrate 1102 can be removed from the second substrate 1108 with minimal effort due to the attractive magnetic forces of the first magnetic device 1116 and the repelling magnetic forces of the second magnetic device 1120.

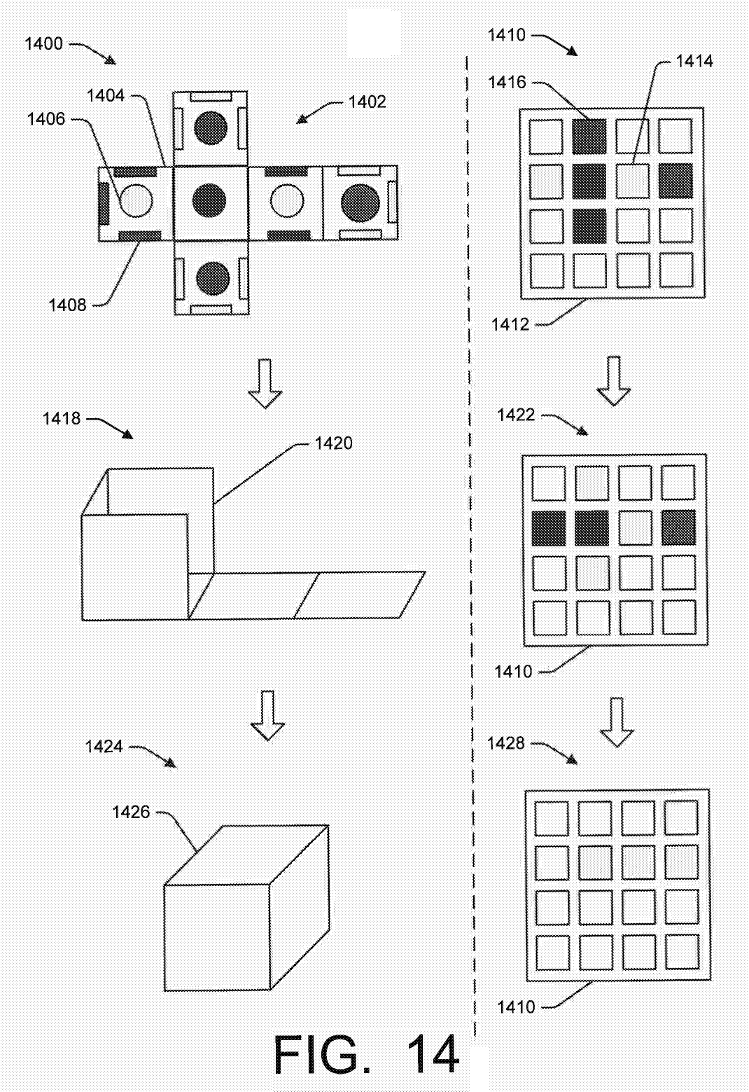

FIG. 14 illustrates the use of a magnetic device to form objects from a substrate. The illustrative example of FIG. 14 includes a top view 1400 of a substrate 1402 that includes a number of respective parts, such as a representative part 1404. Each part of the substrate 1402 can include a primary magnetic ink portion, such as a primary magnetic ink portion 1406 of the part 1404. Each part of the substrate 1402 can also include one or more secondary magnetic ink portions, such as a secondary magnetic ink portion 1408 of the part 1404.

The primary magnetic ink portions and the secondary magnetic portions of the parts of the substrate 1402 can have a respective polarity represented by the shading of the particular magnetic ink portion. For example, the primary magnetic ink portion 1406 has a first polarity and the secondary magnetic ink portion 1408 has a second polarity that is opposite the first polarity. By applying a magnetic field to the primary magnetic ink portions, the secondary magnetic ink portions can be joined to form an object. To illustrate, the illustrative example of FIG. 14 includes a first top view 1410 of a magnetic device 1412 that can be used to form an object from the substrate. In particular, current can be applied to the magnetic device 1412 to cause magnetic components of the magnetic device 1412 to have a respective polarity according to a pattern that can move the parts of substrate 1402 due to the attractive or repelling forces exerted on the magnetic ink portions of the substrate 1402 by the magnetic fields of the magnetic components of the magnetic device 1412. In the illustrative implementation of FIG. 14, the magnetic device 1412 includes a first representative magnetic component 1414 having the first polarity and a second representative magnetic component 1416 having the second polarity.

The illustrative example of FIG. 14 also includes a first orthogonal view 1418 of an intermediate object 1420 produced by applying a pattern of magnetic fields shown in a second top view 1422 of the magnetic device 1412 to the substrate 1402. The illustrative example of FIG. 14 also includes a second orthogonal view 1424 of a final object 1426 produced by applying a pattern of magnetic fields shown in a third top view 1422 of the magnetic device 1410 to the intermediate object 1420. The portions of magnetic ink disposed on the parts of the substrate 1402 are omitted from the intermediate object 1420 and the final object 1426 for clarity of illustration.

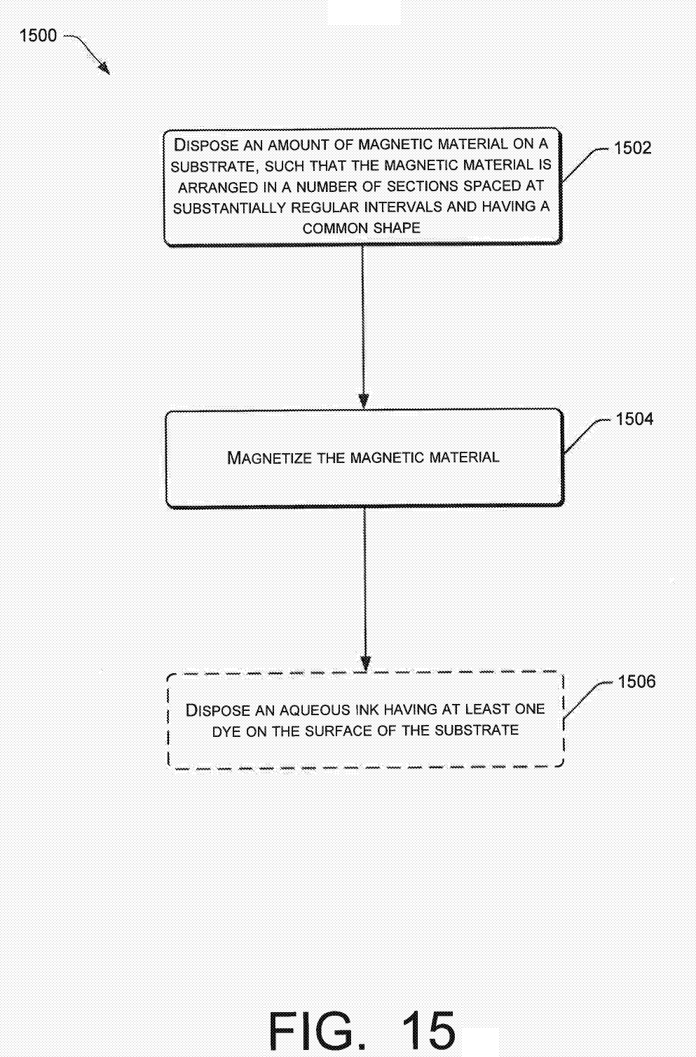

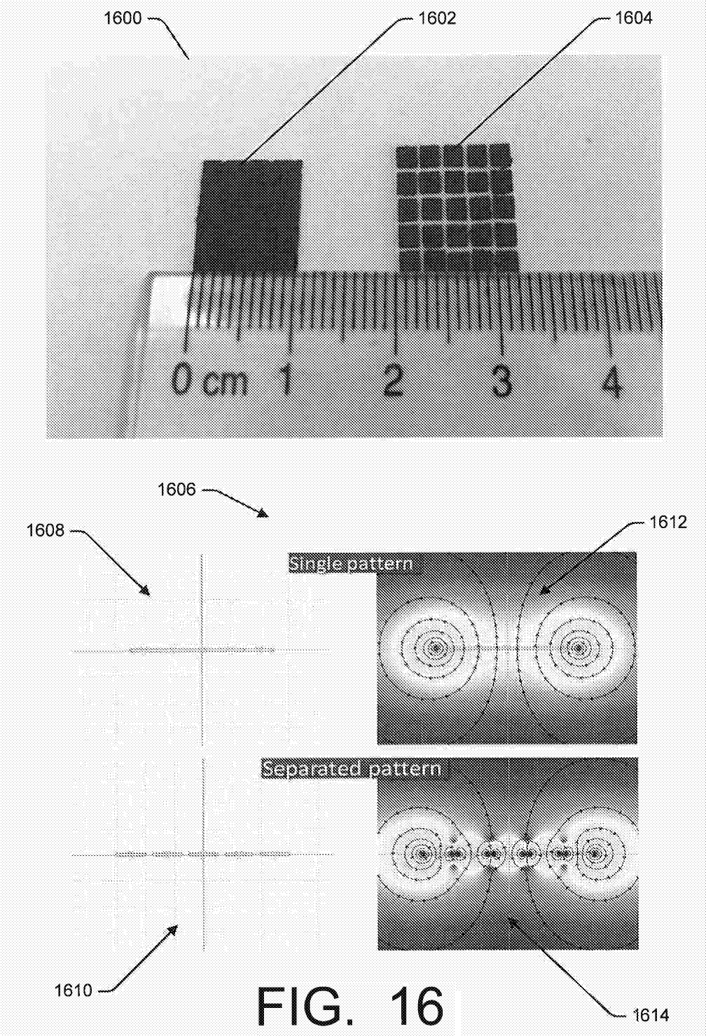

In the flow diagram of FIG. 15, each block represents one or more operations. In some cases, at least a portion of the one or more operations of each block can be performed by an apparatus according to computer-executable instructions processed by a control system of the apparatus. In other cases, at least a portion of the one or more operations of each block can be performed manually. The order in which the blocks are described is not intended to be construed as a limitation, and any number of the described operations can be combined in any order and/or in parallel to implement the processes.

FIG. 15 illustrates a flow diagram of an example process 1500 to form a substrate having a magnetic material disposed on at least one surface of the substrate. At 1502, the method 1500 can include disposing an amount of magnetic material on a surface of a substrate. The magnetic material can be disposed on the surface of the substrate such that the magnetic material is arranged in a number of sections spaced at substantially regular intervals and having a common shape. In some cases, the magnetic material can include a magnetic ink having particles that can be magnetized when located near a magnetic field. In some cases, the magnetic material can be disposed on multiple surfaces of the substrate. In an implementation, a thickness of the substrate can be included in a range of about 0.05 mm to about 0.4 mm. Additionally, a thickness of the magnetic material disposed on the surface of the substrate can be included in a range of about 0.05 mm to about 0.4 mm.

At 1504, the process 1500 includes magnetizing the magnetic material disposed on the at least one surface of the substrate. The magnetic material can be magnetized by placing the magnetic material under the influence of a magnetic field. For example, the magnetizing device can be moved to be disposed proximate to the magnetic material and then a magnetic field can be generated by the magnetizing device to magnetize the magnetic material. In some cases, the magnetic field can be generated by the apparatus used to dispose the magnetic material onto the substrate. In other cases, a device separate from the apparatus used to dispose the magnetic material onto the substrate can magnetize the magnetic material.

In an implementation, the magnetic material can be magnetized such that a first portion of particles of the magnetic material are arranged in a first direction and have a first polarity. Additionally, the magnetic material can also be magnetized such that a second portion of particles of the magnetic material are arranged in a second direction and have a second polarity. The second direction can be opposite the first direction and the second polarity can be opposite the first polarity. In an illustrative example, the first portion of the particles of the magnetic material can have a north pole, while the second portion of the particles of the magnetic material can have a south pole. Furthermore, the first portion of particles of the magnetic material and the second portion of particles of the magnetic material can be arranged in a direction perpendicular to the surface of the substrate, in some instances. In other scenarios, the first portion of particles of the magnetic material and the second portion of particles of the magnetic material can be disposed in a direction parallel to the surface of the substrate. After magnetizing the magnetic material, the magnetic material can have a magnetic flux included in a range of about 700 millitesla to about 900 millitesla.

At 1506, the process can optionally include disposing an aqueous non-magnetic ink having at least one dye on the surface of the substrate. The aqueous ink can be used to print characters, such as letters, numbers, symbols, etc. onto the substrate. The aqueous ink can also be used to print pictures onto the substrate. In some cases, the apparatus used to print the aqueous ink onto the substrate can be the same apparatus used to dispose the magnetic ink onto the substrate. In other situations, a different apparatus can be used to print the aqueous ink onto the substrate than the apparatus used to dispose the magnetic material onto the substrate. In some cases, a thickness of a layer of the non-magnetic ink aqueous ink disposed on the substrate can be included in a range of about 0.05 mm to about 0.20 mm.

### EXAMPLE CLAUSES

A. A method comprising: disposing an amount of a magnetic material on a portion of a surface of a substrate such that the amount of the magnetic material is divided into a plurality of sections, individual sections of the plurality of sections being spaced at substantially regular intervals and having a common shape.

B. The method of clause A, wherein disposing the magnetic material on the substrate includes printing an ink on the substrate, the ink including the magnetic material, and the method further comprising printing an additional ink on the substrate, wherein the additional ink includes water and at least one dye.

C. The method of clause A or B, further comprising magnetizing the magnetic material by applying a magnetic field to the magnetic material, and wherein magnetizing the magnetic material causes a plurality of first particles to have a first polarity and causes a plurality of second particles to have a second polarity.

D. The method of clause C, wherein magnetizing the magnetic material includes arranging, on the surface of the substrate, the plurality of first particles and the plurality of second particles such that the plurality of first particles is disposed adjacent to the plurality of second particles in a direction substantially parallel to the surface of the substrate.

E. The method of clause C, wherein magnetizing the magnetic material includes arranging, on the surface of the substrate, the plurality of first particles and the plurality of second particles such that the plurality of first particles is disposed adjacent to the plurality of second particles in a direction substantially perpendicular to the surface of the substrate.

F. The method of any of clauses A to E, wherein the substrate is a first substrate, the amount of the magnetic material is a first amount of the magnetic material, and the plurality of sections is a first plurality of sections, and the method further comprising: disposing a second amount of the magnetic material on a portion of a second substrate such that the second amount of the magnetic material is divided into a second plurality of sections, individual sections of the second plurality of sections being spaced at substantially regular intervals and having the common shape.

G. The method of clause F, wherein a first polarity of at least a first portion of the first plurality of sections is opposite a second polarity of at least a second portion of the second plurality of sections, and the method further comprising: placing the first substrate proximate to the second substrate such that the first portion of the first plurality of sections is attracted to the second portion of the second plurality of sections and an edge of the first substrate contacts an edge of the second substrate.

H. An article comprising: a substrate; and an amount of a magnetic material disposed on a portion of a surface of the substrate such that the amount of the magnetic material is divided into a plurality of sections, individual sections of the plurality of sections being spaced at substantially regular intervals and having a common shape.

I. The article of clause H, wherein the substrate includes cellulose and the magnetic material includes neodymium particles having a diameter no greater than about 100 micrometers.

J. The article of clause H or I, wherein the magnetic material has a magnetic flux included in a range of about 700 millitesla to about 900 millitesla.

K. The article of clause any of clauses H to J, wherein a percent ratio of an area of the surface of the substrate to an area occupied by the amount of the magnetic material is included in a range of about 30% to about 70%.

L. The article of any of clauses H to K, further comprising an aqueous ink disposed on the surface of the substrate, the aqueous ink having at least one dye and the aqueous ink at least partly overlaying the magnetic material disposed on the portion of the surface of the substrate.

M. The article of any of clauses H to L, wherein a thickness of the substrate is included in a range of about 0.05 mm to about 0.4 mm and a thickness of a layer of the magnetic material disposed on the surface of the substrate is included in a range of about 0.05 mm to about 0.4 mm.

N. The article of any of clauses H to M, wherein an additional amount of the magnetic material is disposed on an additional surface of the substrate, the additional surface of the substrate being opposite of the surface of the substrate and parallel to the surface of the substrate.

O. An apparatus comprising: a printing component including a container storing an ink including a magnetic material; a magnetizing device; and a control system comprising: one or more processors; and one or more computer storage media storing instructions executable by the one or more processors to perform operations comprising: printing an amount of the ink on a portion of a surface of a substrate such that the amount of the ink is divided into a plurality of sections, individual sections of the plurality of sections being spaced at substantially regular intervals and having a common shape.

P. The apparatus of clause O, wherein: the printing component is a first printing component, the container is a first container, and the ink is a first ink; the apparatus further comprises a second printing component including a second container including a second ink that includes water and at least one dye; and the operations further comprise printing the second ink on the surface of the substrate.

Q. The apparatus of clause P, wherein: the first printing component, the second printing component, and the magnetizing device are disposed in a housing mounted on a rail; and the operations further comprise: printing the first ink and the second ink on the surface of the substrate by moving the housing in a horizontal direction along the rail; and magnetizing the magnetic material by moving the housing along the rail such that the magnetizing device is disposed proximate to the magnetic material.

R. The apparatus of clause Q, wherein the housing is a first housing, the surface of the substrate is a first surface of the substrate, and the magnetizing device is a first magnetizing device; the apparatus further comprises a second housing including a third printing component including a third container storing a third ink that includes the magnetic material, a fourth printing component including a fourth container storing a fourth ink that includes water and one or more dyes, and a second magnetizing device; and the operations further comprise printing the third ink and the fourth ink on a second surface of the substrate that is opposite the first surface and parallel to the first surface.

S. The apparatus of clause R, wherein the first magnetizing device includes a first magnetic component and the second magnetizing device includes a second magnetic component, and the operations further comprise magnetizing the magnetic material on the portion of the first surface of the substrate by applying current to the first magnetic component and the second magnetic component.

T. The apparatus of any of clauses O to Q, wherein the magnetizing device includes a first magnetic component and a second magnetic component, and the operations further comprise magnetizing the magnetic material on the portion of the surface of the substrate by applying current to the first magnetic component and the second magnetic component.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification.

### EXAMPLES

A substrate having portions of magnetic ink was produced using a powder comprising a magnetic material. In particular Molycorp Magnequench powder having product number MQFP 14-12-20000 and a particle size of about 5 micrometers was provided. An epoxy resin was also provided and mixed with the powder of magnetic material. A weight ratio of amount of magnetic powder to amount of epoxy resin was about 5:1. The density of the epoxy resin was about 1.10 g/cm³ and the apparent density of the magnetic powder was about 1.6 g/cm³ with a theoretical density of about 7.5 g/cm³. The volume ratio of magnetic powder to epoxy resin was about 3.4:1. The content of magnetic powder in the epoxy resin/magnetic powder ratio was about 77.5% by volume. After mixing the magnetic powder with the epoxy resin, the mixture was applied to a paper substrate and leveled such that the layer of the epoxy resin/magnetic powder mixture was about 0.1 mm and was substantially uniform.

The magnetic powder was magnetized using a polymeric apparatus including two neodymium magnets having a grade of N35. The magnets were about 20 mm in diameter and about 20 mm in height. The surface flux density of the magnets was about 500 millitesla (mT). The substrate having the magnetic material was placed between the two magnets to magnetize the magnetic powder disposed on the substrate. Due to the narrow distance between the magnets, the magnetic flux density applied to the magnetic powder on the substrate was about 3.5 T. The typical magnetic flux density for magnetizing the magnetic powder is between about 1.2 T and about 2.0 T.

There are two types of patterns for printing magnetic powder, one has a substantially continuous layer of magnetic powder disposed on the surface of a substrate and the other has approximately a same amount of magnetic powder disposed on the surface of the substrate that is divided into a number of sections. FIG. 16 includes an image 1600 that shows the first sample 1602 and the second sample 1604. The squares of the second sample are separated by a space of about 0.5 mm that occurs about every 2 mm. The total magnetic area for the magnetic powder of the first sample 1602 is about 1 cm² and the total magnetic area for the magnetic powder of the second sample 1604 is about 1 cm².

FIG. 16 also includes an example of simulated results 1606 that show the first condition 1608 (single pattern) and the second condition 1608 (separated pattern), with both conditions having approximately the same amount of magnetic powder and thickness. The magnetic flux was simulated for both conditions and FIG. 16 also includes a first image 1612 showing the magnetic flux of the first condition (single pattern) and a second image 1614 showing the magnetic flux of the second condition (separated pattern). The colors of the magnetic flux of the first image 1612 and the magnetic flux of the second image 1614 represent the density of the magnetic flux with red, yellow, and green expressing a stronger density of the magnetic flux than the blue colors. As can be seen by the simulated results 1606, the magnetic flux density shown in the second image 1614 is stronger across the entire length of the sample than the magnetic flux density shown in the first image 1612 indicating that a separated pattern can provide greater attractive (and repulsive) power compared with single pattern when substrates are stacked.

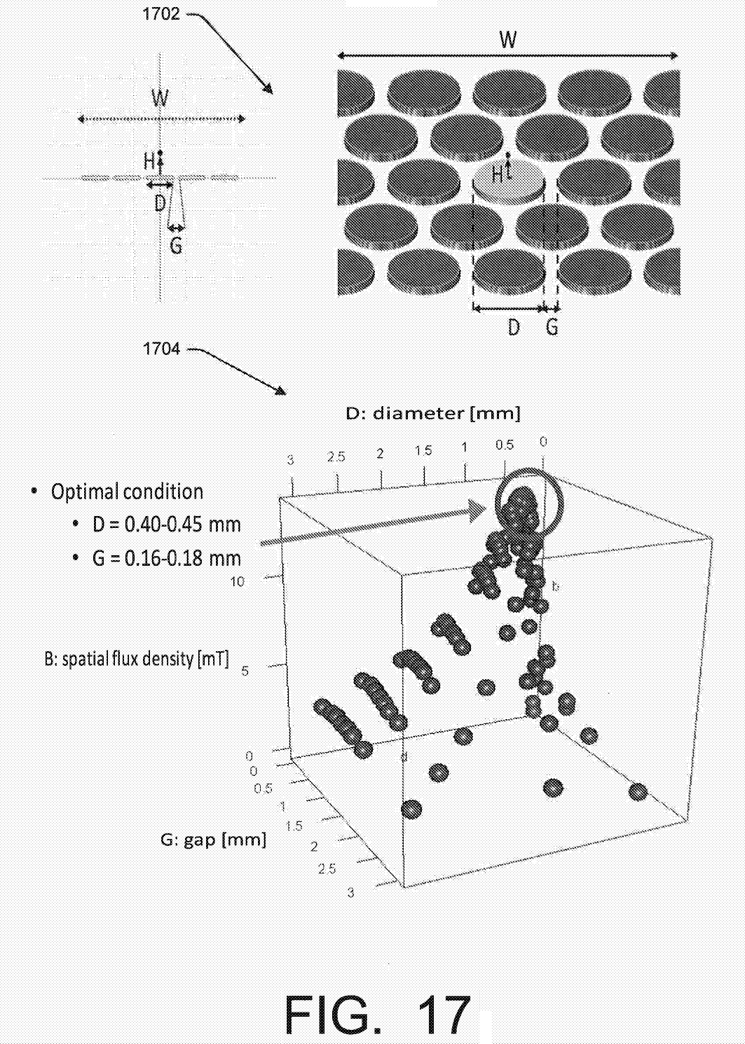

FIG. 17 shows another example of simulated result for finding optimal separated patterns. Conditions of the simulation are shown in 1702. In this simulation, a continuous dot pattern that has diameter (D) and gap (G) is used, and magnetic flux density at the measuring point (P) was calculated. The measuring point (P) was located at the center position of the center dot, and the height of the measuring point (H) is 0.1 mm from the surface of magnetic powder disc (for representing the thickness of the substrate). Thickness of the magnetic powder was fixed as 0.1 mm. The width of the entire pattern (W) was also fixed at 10 mm due to limitation of the simulator.

1704 shows the simulation result for various diameter (D) and gap (G) combinations. It shows optimal conditions are approximately D: 0.40-0.45 mm and G: 0.16-0.18 mm. This result is just an example, and optimal patterns may vary for other conditions such as different dot shapes, and also different thickness of substrate.

1. An apparatus comprising:
a printing component including a container storing an ink including a magnetic material;
a magnetizing device; and
a control system comprising:
one or more processors; and
one or more computer storage media storing instructions executable by the one or more processors to perform operations comprising:
printing an amount of the ink on a portion of a surface of a substrate such that the amount of the ink is divided into a plurality of sections, individual sections of the plurality of sections being spaced at substantially regular intervals and having a common shape.

2. The apparatus of claim 1, wherein:
the printing component is a first printing component, the container is a first container, and the ink is a first ink;
the apparatus further comprises a second printing component including a second container including a second ink that includes water and at least one dye; and
the operations further comprise printing the second ink on the surface of the substrate.

3. The apparatus of claim 2, wherein:
the first printing component, the second printing component, and the magnetizing device are disposed in a housing mounted on a rail; and
the operations further comprise:
printing the first ink and the second ink on the surface of the substrate by moving the housing in a horizontal direction along the rail; and
magnetizing the magnetic material by moving the housing along the rail such that the magnetizing device is disposed proximate to the magnetic material.

4. The apparatus of claim 3, wherein the housing is a first housing, the surface of the substrate is a first surface of the substrate, and the magnetizing device is a first magnetizing device;
the apparatus further comprises a second housing including:
a third printing component including a third container storing a third ink that includes the magnetic material,
a fourth printing component including a fourth container storing a fourth ink that includes water and one or more dyes, and
a second magnetizing device; and
the operations further comprise printing the third ink and the fourth ink on a second surface of the substrate that is opposite the first surface and parallel to the first surface.

5. The apparatus of claim 4, wherein the first magnetizing device includes a first magnetic component and the second magnetizing device includes a second magnetic component, and the operations further comprise magnetizing the magnetic material on the portion of the first surface of the substrate by applying current to the first magnetic component and the second magnetic component.

6. The apparatus of claim 1, wherein the magnetizing device includes a first magnetic component and a second magnetic component, and the operations further comprise magnetizing the magnetic material on the portion of the surface of the substrate by applying current to the first magnetic component and the second magnetic component.

7. A method comprising:
disposing an amount of a magnetic material on a portion of a surface of a substrate such that the amount of the magnetic material is divided into a plurality of sections, individual sections of the plurality of sections being spaced at substantially regular intervals and having a common shape.

8. The method of claim 7, wherein disposing the magnetic material on the substrate includes printing an ink on the substrate, the ink including the magnetic material, and the method further comprising printing an additional ink on the substrate, wherein the additional ink includes water and at least one dye.

9. The method of claim 7, further comprising magnetizing the magnetic material by applying a magnetic field to the magnetic material, and wherein magnetizing the magnetic material causes a plurality of first particles to have a first polarity and causes a plurality of second particles to have a second polarity.

10. The method of claim 9, wherein magnetizing the magnetic material includes arranging, on the surface of the substrate, the plurality of first particles and the plurality of second particles such that the plurality of first particles is disposed adjacent to the plurality of second particles in a direction substantially parallel to the surface of the substrate.

11. The method of claim 9, wherein magnetizing the magnetic material includes arranging, on the surface of the substrate, the plurality of first particles and the plurality of second particles such that the plurality of first particles is disposed adjacent to the plurality of second particles in a direction substantially perpendicular to the surface of the substrate.

12. An article comprising:
a substrate; and
an amount of a magnetic material disposed on a portion of a surface of the substrate such that the amount of the magnetic material is divided into a plurality of sections, individual sections of the plurality of sections being spaced at substantially regular intervals and having a common shape.

13. The article of claim 12, wherein:
the substrate includes cellulose and the magnetic material includes neodymium particles having a diameter no greater than about 100 micrometers;
a thickness of the substrate is included in a range of about 0.05 mm to about 0.4 mm; and
a thickness of a layer of the magnetic material disposed on the surface of the substrate is included in a range of about 0.05 mm to about 0.4 mm.

14. The article of claim 12, wherein the magnetic material has a magnetic flux included in a range of about 700 millitesla to about 900 millitesla.

15. The article of claim 12, wherein a percent ratio of an area of the surface of the substrate to an area occupied by the amount of the magnetic material is included in a range of about 30% to about 70%.
